(19) United States
(12) Patent Application Publication
(10) Pub. No.: US 2026/0099002 A1
(43) Pub. Date: Apr. 9, 2026

(54) MULTI-MODE OPTICAL FIBER TAPER FOR GENERATING BRILLOUIN RESPONSES FROM FORWARD INTER-MODAL INTERACTIONS WITH FUNDAMENTAL ACOUSTIC MODES, METHODS AND SYSTEMS THEREOF

(71) Applicant: UNIVERSITY OF ROCHESTER, Rochester, NY (US)

(72) Inventors: William Renninger, Rochester, NY (US); Wendao Xu, Rochester, NY (US); Arjun Natarajan Iyer, Rochester, NY (US)

(21) Appl. No.: 18/899,384

(22) Filed: Sep. 27, 2024

Related U.S. Application Data
(60) Provisional application No. 63/586,544, filed on Sep. 29, 2023.

(51) Int. Cl. G02B 6/122; G02B 6/14; H04B 10/2581

(52) U.S. Cl. CPC G02B 6/1228; G02B 6/14; H04B 10/2581

(57) ABSTRACT

A method of generating a Brillouin signal resonance response by forward inter-modal Brillouin scattering with fundamental acoustic modes (FIM-FAM), by generating an optical mode in an optical fiber, wherein the optical mode is a fundamental optical mode; generating another optical mode in another optical fiber, wherein this optical mode is a higher-order optical mode; coupling through a mode selective coupler the pair of optical modes to become coupled optical modes; controlling and transmitting the coupled optical modes within an input multi-mode optical fiber; driving a fundamental acoustic mode in a multi-mode optical fiber taper, wherein at least one Brillouin signal resonance response is generated within the multi-mode optical fiber taper.

This application claims priority from U.S. Provisional App. No. 63/586,544, filed Sep. 29, 2023, which is incorporated herein by reference.

This invention was made with government support under ECCS-1943658 awarded by the National Science Foundation. The government has certain rights in the invention.

### FIELD

This application relates to the field of optomechanical interactions and, in particular, the generation of stimulated Brillouin scattering (SBS).

### BACKGROUND

Brillouin interactions date back 100 years with essential applications for lasers, delay lines, sensing, and fast, tunable and high-resolution microwave photonic filters. In short, optical and acoustic waves couple through electrostrictive forces where a beat wave between two optical waves induces a density variation in the material which propagates at the speed of sound and modulates the refractive index which then reflects and Doppler shifts one optical tone to amplify the other optical tone. It is a lossless parametric interaction for which the interaction frequency is determined by simple energy and momentum conservation laws. In the standard configuration, the acoustic frequency is lower than the optical frequency by the ratio of the light speed to sound speed, giving ˜10 GHz for most solids. The linewidth of the response is given by the decay rate of the acoustic waves which for this high frequency is ˜40 MHz linewidth. Since the acoustic-wave parameters are fixed by the material, the linewidth response and the performance of devices based on previous interactions is fundamentally limited.

### SUMMARY

One aspect of the application relates to a multi-mode optical fiber taper for forward inter-modal Brillouin scattering with fundamental acoustic modes (FIM-FAM), comprising: a first multi-mode fiber section having a first radius; a second multi-mode fiber section having a second radius; an axially homogeneous waist section having a third radius, wherein the third radius is smaller than the first radius and the second radius; a first tapered transition section adiabatically connecting the first multi-mode fiber section to the waist section; and a second tapered transition section adiabatically connecting the waist section to the second multi-mode fiber section.

Another aspect of the application relates to a system of generating a Brillouin signal resonance response by forward inter-modal Brillouin scattering with fundamental acoustic modes (FIM-FAM), comprising: a multi-mode optical fiber taper as described herein; and a plurality of polarization controllers optically connected to the first multi-mode fiber section of the taper.

Another aspect of the application relates to a method of generating a Brillouin signal resonance response by forward inter-modal Brillouin scattering with fundamental acoustic modes (FIM-FAM), comprising the steps of: generating a first optical mode in a first optical fiber, wherein the first optical mode is a fundamental optical mode; generating a second optical mode in a second optical fiber, wherein the second optical mode is a higher-order optical mode; coupling through a mode selective coupler the first optical mode to the second optical mode to become coupled optical modes; controlling through a plurality of polarization controllers polarization of the coupled optical modes; transmitting the coupled optical modes within an input multi-mode optical fiber, wherein the input multi-mode optical fiber is connected to said plurality of polarization controllers; driving a fundamental acoustic mode in a multi-mode optical fiber taper as described herein, wherein the coupled optical modes enter the multi-mode optical fiber taper from the input multi-mode optical fiber taper; wherein at least one Brillouin signal resonance response is generated within the multi-mode optical fiber taper.

Another aspect of the application relates to a multi-mode optical fiber taper as described herein, made by a process comprising the steps of: heating a multi-mode optical fiber; elongating the multi-mode optical fiber to form a taper.

### BRIEF DESCRIPTION OF THE DRAWINGS

FIG. 1 shows two counter propagating optical fields, pump and Stokes are coupled via a freely propagating longitudinal acoustic wave.

FIG. 2 shows Backward Brillouin interaction. (Upper Panel) acoustic dispersion with the optical driving wavevector overlaid. The intersection point is the allowed interaction, where the phonon has an approximate wavevector magnitude of |q|≈2 kₚ. (Lower Panel) Measurements from the study of the standard high frequency 37-MHz response from an optical fiber.

FIG. 3 shows Panel a) Phase matching and energy conservation diagrams for anti-Stokes scattering process. Panel b) Frequency response of a backward Brillouin system showing gain and loss bands created in the presence of a strong optical pump.

FIG. 4 shows the acoustic dispersion diagram for Forward Intermodal (FIM) Brillouin scattering. Two co-propagating optical fields, pump and stokes, in different spatial optical modes are coupled either through a higher order guided acoustic mode (non-tunable FIM) or fundamental acoustic modes (FIM-FAM). The acoustic dispersion profiles for the modes of the taper waist are shown. While the higher-order acoustic modes have a fixed nonzero cutoff frequency at q=0, the fundamental mode frequencies (Ω) and wavevectors (q) extend continuously to zero. Optomechanical interactions are possible at frequencies where the optical wavevector difference (Δβ) intersects the acoustic dispersion curves. In contrast to interactions with the higher-order modes, FIM-FAM interactions with the fundamental modes can be tuned in frequency by varying the optical wavevector difference, Δβ.

FIG. 5 shows an illustration of the FIM-FAM process in a few-mode taper. Regions of the taper are labeled above each section. Pump (ωωPP) and Stoke (ωωSS) beams input respectively into the fundamental and higher-order spatial modes of the input fiber core couple through the transition region into the fundamental mode and higher-order mode family of the taper waist, where the pump light is optomechanically coupled to the Stokes field through the FIM-FAM process before being coupled out of the device in the two modes of the output fiber core through the second transition region. The phase-matching relations for the FIM-FAM interaction indicating the optical wavevector difference between the axial wavevector of the two participating optical modes, Δββ, must equal the acoustic wavevector, qq, is inset below the device.

FIG. 6 shows the wide new range of acoustic frequencies, lifetimes, and linewidths that can be accessed through FIM-FAM optomechanical interactions.

FIG. 7 shows optical and acoustic modes of a fiber taper. (Panel a) The optomechanical modes of the taper waist are calculated assuming a uniform cylinder with length (L) and diameter (d=2r, for radius r). (Panel b) The effective refractive index of the optical modes as a function of taper radius. (Panel c) Electric field distributions of the first four optical modes, which participate in the FIM-FAM process under consideration. (Panel d) Displacement profiles of the fundamental acoustic modes confined in the taper waist. The glass-air boundary is indicated with dashed circles.

FIG. 8 shows optomechanical coupling strength calculations for the FIM-FAM interaction. (Panel a) Calculated acoustic dispersion profiles for a taper waist with r=830 nm, including three fundamental (lower) and several higher-order (upper) acoustic modes. The optical wavevector differences between the fundamental optical mode and three higher-order modes are indicated by vertical dashed lines. (Panel b) The spatial distribution of the relevant x-components of the optical forces (bulk electrostriction fₑₛ in red, surface electrostriction Fₑₛ in orange, radiation pressure Fᵣₚ in green) for FIM-FAM interactions between the fundamental mode and each of the three higher-order modes along with the x-component of acoustic displacement of the fundamental flexural mode. (Panel c) The relative contributions of the three optical forcing mechanisms and the combined vectorial sum giving the total FIM-FAM gain.

FIG. 9 shows the whole fiber taper structure and the protective packing process. 9, (Panel a) FIM-FAM occurs between the co-propagating strong optomechanical pump (frequency ω_{P}, wavevector β_{P}) and the weak optomechanical probe (frequency ωₚᵣ, wavevector βₚᵣ), each guided in separate spatial optical modes, and is mediated by the fundamental acoustic wave (frequency Ω, wavevector q). The Stokes (anti-Stokes) process corresponds to when the probe frequency ωₚᵣ is smaller (larger) that the pump frequency ω_{P}. The optical wavevectors are proportional to the effective refractive indices n_{eff} of the guiding optical modes as β=2πh_{eff}/λ, where λ is the free-space wavelength. In the Stokes process, assuming the pump is guided in a mode with a larger effective index than the probe, the energy conservation and phase-matching conditions require that ω_{P}=ωₚᵣ+Ω and β_{P}=βₚᵣ+q, so that the mediated acoustic wave travels in the same direction as the pump and probe. 9, (Panel b) Due to the non-cutoff nature of the fundamental acoustic modes combined with the small phase-matched acoustic wavevector realized by FIM-FAM, the FIM-FAM frequency can be significantly lower than that of other types of Brillouin interactions, resulting in a much narrower Brillouin linewidth. 9, (Panel c) The strong FIM-FAM pump and the weak Stokes sideband are separately coupled from the input fiber into different guided optical modes at the taper waist through the input transition region. At the waist region, the Stokes sideband within a narrow frequency range (determined by the FIM-FAM linewidth Δf) away from the FIM-FAM pump by the FIM-FAM frequency f_{OM} is selectively amplified through the FIM-FAM process. After the waist region, the pump and the amplified Stokes are coupled into the output fiber through the output transition region. The mild fluctuation of the waist radius due to realistic fabrication uncertainty is qualitatively represented in the magnified inset on the top. Illustration of the fiber taper packaging is shown in the bottom inset. After the fiber taper fabrication, the taper embodiment is immediately transferred carefully into a hollow stainless steel sealing tube, with two 3D-printed sealers sealing both ends of the tube. The sealing tube is much wider in its diameter compared to the whole fiber taper to not influence the light propagation. The fiber extrudes out of the sealers through small central holes on them. The fiber taper is then gently stretched axially and glued to the sealers to maintain its intactness during the transportation and FIM-FAM measurements. 9, (Panel d) For FIM-FAM in few-mode fiber tapers, the optomechanical gain coefficient can be calculated with the vectorial overlap on the cross-section between the optical forces generated by the two optical modes, and the displacement field of the phase-matched fundamental flexural mode.

FIG. 10 shows design and fabrication of the fiber taper. (Panel a) An illustration of the fabrication process. (Panel b) The triple-stage fabrication originally designed for low-loss single mode fiber tapers.

FIG. 11 shows initial fiber taper characterization. (Panel a) Backward traveling-wave optomechanics measurement. (Panel b) Optical backscatter reflectometry measurement characterizing the axial length of the taper waist and transition regions. The waist region is roughly defined between the two vertical green lines, and the two transition regions are roughly defined between two neighboring lines on either side of the waist.

FIG. 12 shows the FIM-FAM measurement setup. (Panel a) The diagram of the measurement setup. The acoustic drive 1 is created and coupled into the fundamental mode of the few-mode taper through a mode selective coupler (MSC). The acoustic drive 2 and the probe are created and coupled into the higher-order optical modes of the few-mode taper through the same mode selective coupler. The generated FIM-FAM signal is then coupled into the following single-mode fiber with a properly chosen lens and a fiber collimator. The acoustic drives are then filtered out of the system by two additional FBG filters. The FIM-FAM signal is then sent into the photodetector with a local oscillator directly from the laser for the sensitive heterodyne detection. Several polarization controllers (PC) are used for precise controls of the modes throughout the measurement setup. (Panel b) The frequency relations of all the optical tones. Since ω_{d1}>ω_{d2}, only the phase-matched anti-Stokes sideband of the probe can be efficiently generated, while the Stokes sideband is absent. (Panel c) The experimental spectrum spanning the frequency range of 1.5 GHz to 4 GHz. Two acoustic modes are expected. (Panel d) The zoom-in spectrum of the TR₂₁ resonance, covering a frequency range of 2.24 GHz to 2.29 GHz. (Panel e) The zoom-in spectrum of the R₀₁ resonance, covering a frequency range of 3.02 GHz to 3.10 GHz. Both resonances in c-d) correspond to a radius range of 604 nm to 619 nm.

FIG. 13 shows FIM-FAM measurement results. a-b) The normalized FIM-FAM signal within a frequency range of 150 MHz-350 MHz. To individually investigate the HE11-TE01 and HE11-TM01 FIM-FAM resonances, the optical power of the two higher-order modes is alternately maximized. The level of the non-phase-matched Stokes sideband is much weaker compared to the phase-matched anti-Stokes sideband. Far away from the resonances, the background originated from electrical noises with input light, as can be validated from the drive-off measurements without any kind of four-wave mixing. a) The optical power in the TE01 mode is maximized, with the HE11-TE01 signal ˜45 dB higher than the background and ˜42 dB higher than the suppressed HE11-TM01 signal. b) The optical power in the TM01 mode is maximized, with the HE11-TM01 signal ˜34 dB higher than the background and ˜30 dB higher than the suppressed HE11-TE01 signal. c) The comparison of the normalized HE11-TE01 and HE11-TM01 FIM-FAM signals in the linear scale, showing the FIM-FAM resonances in detail with labelled 3-dB linewidth of the major peaks.

FIG. 14 shows hypothetical taper waist profiles, with comparisons showing the necessity on the modification of the original phonon self-interference model. (Panel a) Three different hypothetical profiles of the taper waists estimated based on the experimental spectrum, connected to the transition regions before and after the taper waist. Zoom-in plots of the profiles are on top of the figure as an inset within a 50 nm radius range. (Panel b) In the total four different configurations, the original phonon self-interference model can be used to correctly anticipate the similarities of the FIM-FAM spectra measured in both opposite physical directions and different phase-matched sidebands. (Panel c) Three hypothetical waist profiles are also incorporated into the modified phonon self-interference model to calculate the corresponding FIM-FAM spectra, each yielding distinct responses but still in qualitative agreements with the measurement results.

FIG. 15 shows creation of hypothetical profiles for the modified PSI model. a) Waist profile estimation calculated with deconvolution. b) The probability histogram of the taper radius extracted from a). c) The flow chart of profiles generation from the histogram. d) 3 different hypothetical waist profiles within the same resonant frequency range throughout the waist region.

FIG. 16 shows simulated phase mismatch in the system. (Panel a) The wavevector mismatch at 615 nm radius as a function of the frequency separation between the drives and the probe/signal pair. (Panel b) The accumulated phase mismatch throughout the waist region for different FIM-FAM resonances.

FIG. 17 shows the comparison of the calculated FIM-FAM spectra with between the original and the modified PSI models. (Panel a-c) Spectra calculated with the original model for three different hypothetical profiles, where the configurations [AB]ₒ-[AB]ₐ and [AB]ₒ-[AB]ₐ share the same spectral distribution differing from the experimental results in FIG. 29. (Panel d-f) Spectra calculated with the modified model for three different hypothetical profiles, showing different spectral distributions for the configurations [AB]ₒ-[BA]ₐ and [AB]ₒ-[AB]ₐ. The comparison of the calculated FIM-FAM spectra with the three different hypothetical profiles, highlights the correctly modeled different spectral distributions on the FIM-FAM spectra of the configurations [AB]ₒ-[AB]ₐ, and [BA]ₒ-[BA]ₐ.

FIG. 18 shows the similarity among the FIM-FAM spectra calculated with the modified phonon self-interference models. (Panel a-c) Spectra calculated for the configurations [AB]ₒ-[AB]ₐ, and [BA]ₒ-[AB]ₐ, with three different hypothetical profiles. (Panel d-f) Spectra calculated for the configurations [AB]ₒ-[AB]ₐ a and [BA]ₒ-[BA]ₐ, with three different hypothetical profiles.

FIG. 19 shows comparisons between the experimental HE11-TM01 FIM-FAM spectra and the modelled spectra calculated with three hypothetical profiles, showing qualitative agreements. (Panel a-b) Experimental spectra for configurations [AB]ₒ-[AB]ₐ, and [BA]ₒ-[BA]ₐ. (Panel c-d) Modelled FIM-FAM spectra for configurations [AB]ₒ-[AB]ₐ and [BA]ₒ-[BA]ₐ, for three profiles.

FIG. 20 shows comparisons between the experimental HE11-TE01 FIM-FAM spectra and the modelled spectra calculated with three hypothetical profiles, showing qualitative agreements. (Panel a-b) Experimental spectra for configurations [AB]ₒ-[AB]ₐ and [BA]ₒ-[BA]ₐ. (Panel c-d) Modelled FIM-FAM spectra for configurations [AB]ₒ-[AB]ₐ, and [BA]ₒ-[BA]ₐ, for three profiles.

FIG. 21 shows comparison of the PSI model before and after the modification on the previous FIM-FAM demonstration in an inhomogeneous few-mode fiber taper. The theoretical spectrum remains almost identical, hypothetically due to the much shorter waist length leading to less noticeable phase mismatch.

FIG. 22 shows FIM-FAM spectra calculate with the modified phonon self-interference model, with different ratios of phase mismatch compared to the simulated values. (Panel a) The same phase mismatch value calculated from the numerical simulations. (Panel b) 50%. (Panel c) 20%. (Panel d) 10%. The similarity of FIM-FAM responses modeled with different drives and probe-signal pair reduces with less group velocities difference.

FIG. 23 shows experimental (Panel a) HE11-TE01 and (Panel b) HE11-TM01 FIM-FAM at different frequency separations. The 3-dB linewidths of the major peak change for both resonances. Clearly with larger frequency separations along with different phase mismatch between the drives and the probe-signal pair, the measured FIM-FAM responses have different spectral distributions, which is also influencing the 3-dB linewidth the major peaks as labeled.

FIG. 24 shows comparisons of the experimental spectra with FIM-FAM spectra numerically calculated with the modified phonon self-interference model. The multi-peak responses are successfully reproduced qualitatively. (Panel a) The experimental FIM-FAM spectrum for the HE11-TE01 interaction. ‘exp’ stands for ‘experimental’. (Panel b) The experimental FIM-FAM spectrum for the HE11-TM01 interaction. (Panel c) Modelled FIM-FAM spectra for the HE11-TE01 interaction. (Panel d) Modelled FIM-FAM spectra for the HE11-TM01 interaction. Better matchings between the top and bottom spectra require the exact taper waist profile.

FIG. 25 shows calculated FIM-FAM resonances shift as a function of the waist radius, where each resonance has their own local maximum values around specific radii as the inhomogeneity-insensitive radii (r₁ for HE11-TE01, 12 for HE11-TM01, r₃ for HE11-HE21). The measured FIM-FAM taper embodiment with ˜15 nm radius fluctuation (green bar) is measured to have an average radius closer to the inhomogeneity-insensitive radius of the HE₁₁-TE₀₁ interaction at r₁, compared to the calculated inhomogeneity-insensitive radius of the HE₁₁-TM₀₁ interaction, leading to a smaller frequency variation on the HE₁₁-TE₀₁ interaction represented by Δf₁ over the HE₁₁-TM₀₁ interaction represented by Δf₂.

FIG. 26 shows characterizations of the low-loss fiber taper sample. (Panel a) Backward optomechanical measurement. (Panel b) Optical backscatter reflectometry measurement characterizing the axial length of the taper waist and transition regions. (Panel c) The FIM-FAM spectrum of the HE11-TE01 resonance. (Panel d) The FIM-FAM spectrum of the HE11-TM01 resonance. (Panel e) Zoom-in spectra of the resonances, with still sub-MHz FIM-FAM linewidths labeled for each resonance.

FIG. 27 shows the adiabaticity of the measured taper embodiment, determined by the critical angles of the LP01 and LP11 modes. (Panel a) The illustration of the local taper angle as well the local length-scale. (Panel b) The critical angles and the physical angle of the taper embodiment as a function of the taper outer radius. The local taper angle needs to be smaller to further reduce the optical loss.

FIG. 28 shows four configurations exploring the FIM-FAM responses in different ways. The drive 2 and the probe are designated to propagate in a higher-order mode colored in red, and the drive 1 as well as the generated FIM-FAM signal colored in blue are propagating in the HE11 mode, so that the drive 1 and signal always propagates with larger wavevectors compared to the drive 2 and probe. The relative frequencies of the optical tones are qualitatively labeled in each plot, with propagation directions of the light and mediated acoustic wave labelled in the waist region in the insets on top satisfying the phase matching conditions. (Panel a) [AB]ₒ-[AB]ₐ, the light propagates from end A to end B, with the mediated acoustic wave propagating in the same direction from end A to end B. (Panel b) [AB]ₒ-[AB]ₐ, the light propagates from end A to end B, with the mediated acoustic wave propagating in the opposite direction from end B to end A. (Panel c) [BA]ₒ-[BA]ₐ, the light propagates from end B to end A, with the mediated acoustic wave propagating in the same direction from end B to end A. (Panel d) [BA]ₒ-[BA]ₐ, the light propagates from end B to end A, with the mediated acoustic wave propagating in the opposite direction from end A to end B.

FIG. 29 shows experimental FIM-FAM spectra around the resonances for the four different configurations, for both HE11-TE01 and HE11-TM01 resonances. (Panel a-b) HE11-TE01 interaction. (Panel a) Similarity between the configuration [AB]ₒ-[AB]ₐ, and [BA]ₒ-[AB]ₐ. (Panel b) Similarity between the configuration [AB]ₒ-[BA]ₐ and [BA]ₒ-[BA]ₐ. c-d) HE11-TM₀₁ interaction. (Panel c) Similarity between the configuration [AB]ₒ-[AB]ₐ, and [BA]ₒ-[AB]ₐ. (Panel d) Similarity between the configuration [AB]ₒ-[BA]ₐ and [BA]ₒ-[BA]ₐ.

### DETAILED DESCRIPTION

Reference will be made in detail to certain aspects and exemplary embodiments of the application, illustrating examples in the accompanying structures and figures. The aspects of the application will be described in conjunction with the exemplary embodiments, including methods, materials and examples, such description is non-limiting and the scope of the application is intended to encompass all equivalents, alternatives, and modifications, either generally known, or incorporated here. Unless otherwise defined, all technical and scientific terms used herein have the same meaning as commonly understood by one of ordinary skill in the art to which this application belongs. One of skill in the art will recognize many techniques and materials similar or equivalent to those described here, which could be used in the practice of the aspects and embodiments of the present application. The described aspects and embodiments of the application are not limited to the methods and materials described.

As used in this specification and the appended claims, the singular forms “a,” “an” and “the” include plural referents unless the content clearly dictates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” are also disclosed, as appropriately understood by the skilled artisan. For example, if the value “10” is disclosed, the “less than or equal to 10” and “greater or equal to 10” is also disclosed. When two or more value are disclosed, all possible ranges between any two values are disclosed.

### Overview

This application demonstrates single-resonance, ultranarrow linewidth Forward Inter-Modal optomechanical interaction with Fundamental Acoustic Modes (FIM-FAM) within a long, homogeneous few-mode fiber taper. The fabricated fiber tapers, featuring long waists (˜100 mm) and drastically improved geometric homogeneity (˜2%), also exhibit reduced transmission losses. These advancements result in a total optomechanical gain enhancement at almost two orders of magnitude compared to previous inhomogeneous taper samples. The study demonstrates sub-MHz Brillouin linewidths as narrow as 110 kHz in a few-mode fiber taper with a homogeneous waist region. The tight confinement of optical and acoustic waves yields interaction efficiencies over 1000 times higher than traditional backward Brillouin scattering in standard fibers. A long waist region and low-loss transitions enable total Brillouin strengths nearly two orders of magnitude greater than known. The reduced waist size and comprehensive polarization control suppress unwanted optomechanical sidebands by over 40 dB relative to the signal.

The measurements reveal 3-dB optomechanical linewidths as narrow as 110 kHz, approaching the intrinsic acoustic linewidth and underscoring the potential of FIM-FAM in homogeneous few-mode fiber tapers for a range of specialized optomechanical applications. By concentrating optical power into a minimal number of modes utilizing reduced waist radii, and implementing comprehensive polarization controls, the study achieves signal suppression of unwanted optomechanical sidebands by as high as over 40 dB relative to the target signal. The study also introduces a modified phonon self-interference model, accurately capturing the dynamical evolution of optomechanical signals and long-lived acoustic phonons, while also modeling the distinct FIM-FAM responses when the taper is probed in opposite physical directions. The updated model continuously serves as a potential tool for both analyzing and manipulating the geometrical inhomogeneity in photonic waveguides. The importance of the dispersion engineering of the FIM-FAM devices is highlighted with different spectral distributions among different FIM-FAM resonances.

Furthermore, the study introduces dispersion-dependent homogeneity, demonstrating its utility in controlling and engineering optomechanical linewidths by controlling frequency variations through the central waist radius on top of the geometrical homogeneity in taper samples. This work highlights the importance of both fabrication refinement and polarization management in optimizing the performance of fiber taper devices in narrow linewidth optomechanical systems, achieving world-record 3-dB optomechanical linewidths in strong traveling-wave optomechanical systems.

### Theory-Brillouin Scattering

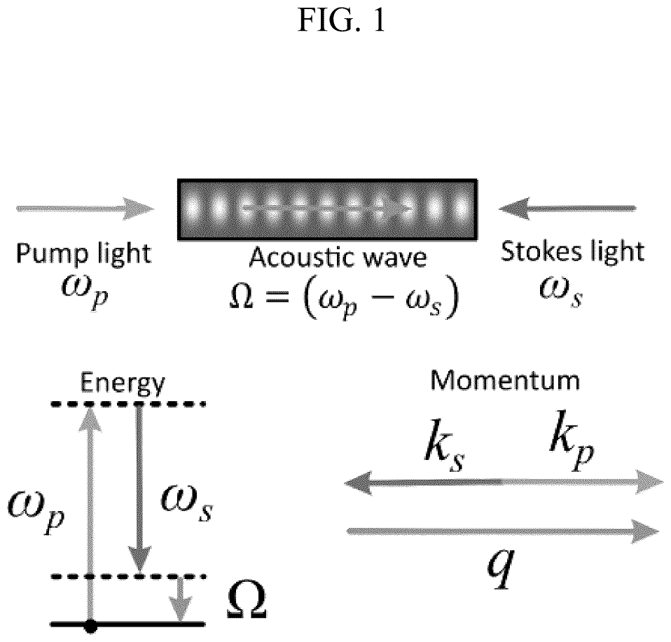

In Brillouin scattering, optical and acoustic waves couple through electrostrictive forces (materials become compressed in the presence of a strong electric field gradient). The beat wave between two counter-propagating optical waves with a small frequency difference induces a density variation in the material (FIG. 1). For the appropriate difference frequency, the density variation will propagate at the speed of sound. This periodic density variation also modifies the refractive index with the same spatial period, which reflects and Doppler shifts the pump light to the frequency of the counter-propagating probe light. In other words, the two optical waves generate an acoustic wave, which then amplifies the probe light.

Brillouin has now been demonstrated in many systems, with useful devices developed in fiber and integrated waveguides. Brillouin has been proven effective for reversing atmospheric distortions in high power lasers, increasing spatial optical coherence, enabling ultranarrow laser sources, and creating optical delay lines. Brillouin is also a very effective sensor for strain and temperature and has more recently seen growing impact for a new form of elastic sensing in tissues. Finally, Brillouin scattering enables fast, tunable and high-resolution optical filters that are well-suited for microwave photonic systems.

### Backward Brillouin Scattering

Energy and momentum conservation laws determine whether the interaction is allowed and if so, what the frequency will be. By understanding these simple conservation laws, it can be seen why the frequency of traditional backward interactions is fixed, and why FIM-FAM interactions are extremely flexible. Considering an optical pump wave with frequency ωₚ, and wavevector (or momentum) kₚ, an optical probe (from now on called Stokes) wave with frequency ωₛ, and wavevector kₛ, and an acoustic wave with frequency Ωₘ, and wavevector qₛ. The conservation equations can be written simply as:

$${ω}_{p} = {ω}_{s} + {Ω}_{m} \qquad ( 1 a )$$

$${\vec{k}}_{p} ( {ω}_{p} ) = {\vec{k}}_{s} ( {ω}_{s} ) + \vec{q} ( {Ω}_{m} ) \qquad ( 1 b )$$

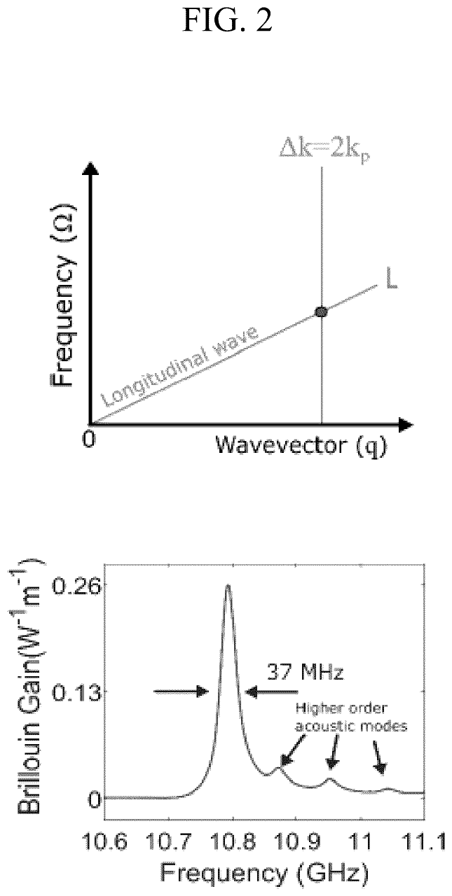

In a waveguide these wavevectors are simplified to scalar quantities for the wavevector component along the waveguide axis. Generally, these two equations can be solved by plugging Eq. 1a into 1b and solving for Ωₘ. The resulting transcendental equation, using the optical wavevector difference, Δk=\vec{k}ₚ−\vec{k}ₛ, is expressed as Δk(ωₚ, Ωₘ)=q(Ωₘ). Because the acoustic dispersion can become complicated (e.g. in waveguides) it is convenient to solve this equation graphically by plotting the optical wavevector difference, Δk(Wp, Ωₘ), on a plot of the acoustic dispersion, q(Ωₘ), and identifying the allowed interactions as the points of intersection (e.g. FIG. 2, upper panel).

In the traditional backward interaction, the optical pump and Stokes fields are counter-propagating, which can be represented by adding a negative sign to the counter-propagating Stokes wavevector. In this case Δk(ωₚ, Ωₘ)=\vec{k}ₚ(ωₚ)−\vec{k}ₛ(ωₚ, Ωₘ)=kₚ(ωₚ)+kₛ(ωₚ, Ωₘ)≈2kₚ(ωₚ). The Ωₘ dependence is ignored because the acoustic frequency (˜10 GHZ) is orders of magnitude smaller than the optical frequencies (˜200 THz). Energy and momentum conservation, Δk(ωₚ, Ωₘ)=q(Ωₘ), for a fixed optical pump frequency (ωₚ), now tell us that the acoustic wave accessed by the backward interaction simply has to satisfy q(Ωₘ)=2 kₚ. The dispersion for freely propagating acoustic waves is q(Ωₘ)=28/vₐ, where vₐ is the acoustic velocity. Graphically, this acoustic dispersion (q(Ωₘ)) line is plotted with slope vₐ and the wavevector difference is plotted as a single value of q, at 2 kₚ. The intersection point determines the allowed Brillouin interaction as Ω_{B}/vₐ=2kₚ, or

$${Ω}_{B} = \frac{4 π {nv}_{a}}{{λ}_{0}} ,$$

where n is the refractive index of the medium and λ₀ is the optical wavelength of the pump.

The acoustic frequency for standard backward Brillouin interactions for most solids is ˜10 GHz for near-infrared optical pumping. This backward interaction occurs with the most ubiquitous freely propagating acoustic waves, which also explains why this is the most common and well-studied interaction. The backward interaction also occurs in acoustic waveguides, but because the acoustic wavevector is so large, the waveguide does not significantly alter the response from the bulk case. An example response measured of the most common standard single-mode fiber yields a strong peak at 10.8 GHz, with several much weaker peaks from higher order acoustic modes (FIG. 2, lower panel). The linewidth of the response given by the decay rate of the acoustic waves is largely determined by the frequency of the interaction, with higher frequencies giving broader linewidths. The 37 MHz linewidth is representative of the high frequency backward interactions and corresponds to acoustic waves that are short lived, decaying after only 100 microns in the fiber. Since the acoustic-wave parameters are fixed by the material, the linewidth response and the performance of devices based on standard backward interactions is fundamentally limited by intrinsic material constraints.

### Overcoming the Limitations of Backward Brillouin Scattering

The limitations of traditional backward Brillouin scattering can be overcome by engineering the momentum through appropriately designed optical and acoustic waveguides.

The Brillouin coupling strength is quantified by a gain coefficient, G₀, which depends on system parameters including the optical wavelength, refractive index, speed of sound, density of the medium and its electrostrictive constant. The gain coefficient quantifies how much amplification the Stokes optical field will experience through

$${P}_{s}^{out} = {P}_{s}^{i n} {e}^{{G}_{0} {P}_{p} L} , \qquad ( 2 )$$

where

$${P}_{s}^{i n}$$

is the initial Stokes power,

$${P}_{s}^{out}$$

is the final Stokes power, Pₚ is the pump power, and L is the length of the Brillouin active medium. G₀ is in units of W⁻¹m⁻¹ such that the exponential's power is unitless. The overall amplification is increased by increasing the pump power, Pₚ, the device length, L, or the intrinsic Brillouin gain, G₀. Therefore, higher Brillouin coupling strength leads to comparable devices with shorter lengths and lower power requirements.

Note that energy flow in a Brillouin interaction is one-directional, from the pump to the Stokes field. It does not oscillate between the pump and Stokes optical fields, even if the pump is heavily depleted. The phonons generated through the Brillouin process have a finite lifetime typically much smaller than optical lifetimes. New pump photons can be only created when the Stokes photon absorbs a phonon to create a pump photon, thereby transferring energy into the pump field. Phonons generated through the Brillouin process are lost comparatively quickly and consequently, the pump field continually loses energy, even if it already is depleted.

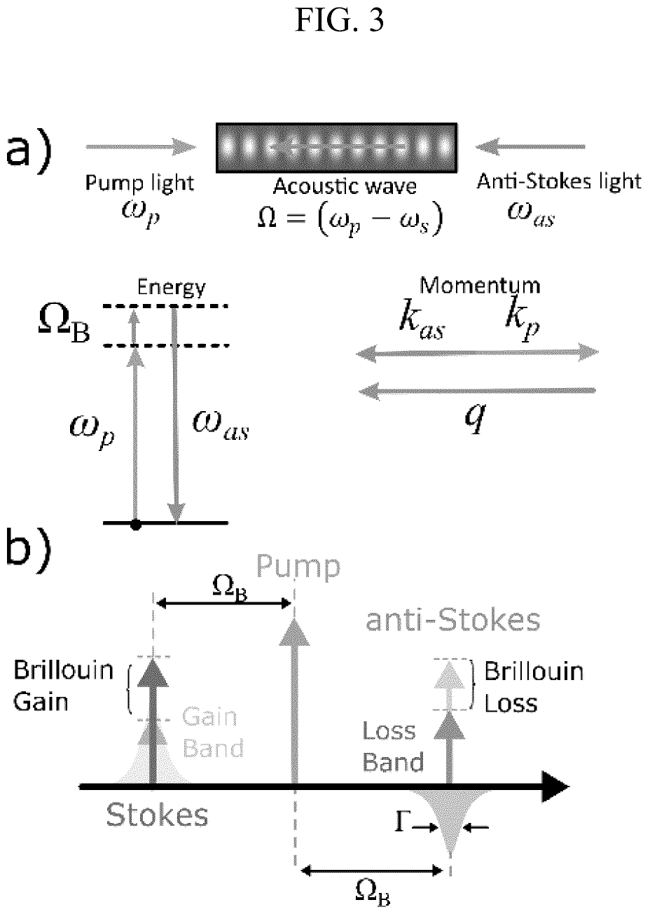

In the Stokes processes described so far, energy is transferred from the optical pump to an acoustic wave and a redshifted optical Stokes tone. Alternatively, in the anti-Stokes process energy from an acoustic wave combines with energy from a pump to create a higher energy, blue-shifted (higher frequency) anti-Stokes optical tone. Importantly, the acoustic wave mediating the anti-Stokes process propagates in the opposite direction to that from the Stokes process (FIG. 3). In the absence of any external acoustic waves, the anti-Stokes tone experiences exponential loss as it propagates, in contrast to exponential gain experienced by the Stokes tone, and its output power

$$( {P}_{a s}^{out} )$$

can be written as

$${P}_{as}^{out} = {P}_{as}^{in} {e}^{- {G}_{0} {P}_{p} L} . \qquad ( 3 )$$

Selecting between Stokes/anti-Stokes processes forms the basis of Brillouin based applications including lasers, amplifiers, and filtes; anti-Stokes processes are well-suited to notch filtering applications.

With a single optical mode, pump and Stokes light propagating in the same direction can couple to guided acoustic waves, leading to Forward Intra-modal Brillouin interactions. While these interactions open up new frequencies and have enabled new devices, as described in more detail below, they have been limited in frequency, linewidth and coupling, as well as by the device geometry.

### Forward Inter-Modal Brillouin Scattering Limitations

With two optical modes with different effective indices much more flexibility becomes available for Brillouin interactions. For a pump propagating in a mode with refractive index n₁ and the Stokes field propagating in another mode with refractive index n₂, the optical wavevector difference becomes Δk=kₚ−kₛ≈(n₁−n₂)k₀=δnk₀, where δn is the difference in refractive index of the two optical modes. For example, a two-mode waveguide for light and a solid cylinder for acoustic guidance is considered. To determine the available interactions, from the analysis above, the dispersion of all of the acoustic modes is analyzed for all of the points where the single value of Δk intersects these curves.

Although this process uses the same acoustic higher order modes as intra-modal scattering, the Stokes and anti-Stokes process in inter-modal scattering uses acoustic waves traveling in opposite directions which is advantageous for applications requiring single-sideband responses. However, like the intramodal interactions, intermodal interactions with the higher order modes are higher frequency with negligible tunability because the higher order modes do not vary in frequency with wavevector. Consequently, using standard fiber geometries, the interaction strength of forward Brillouin is very weak because the light in the fiber core has a very small overlap with the acoustic mode extending out through the cladding.

Overcoming Limitations with Forward Inter-Modal Brillouin Scattering with Fundamental Acoustic Modes (FIM-FAM)

The fundamental acoustic modes exist at all frequencies in bulk and waveguide systems and do not have the lower frequency bound that limits the higher-order acoustic modes. Without a strong dependence of the frequency on the geometry, the fundamental acoustic modes offer a unique opportunity to decouple the frequency (and linewidth) from the confinement and therefore strength of the interaction. The frequency of the interaction can be tuned by the choice of relative effective indices of the participating optical modes (Δk=δnk₀).

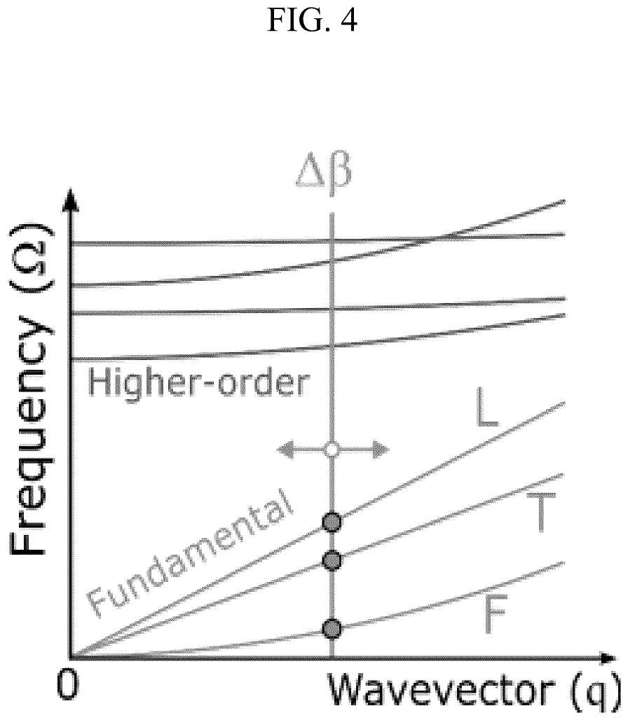

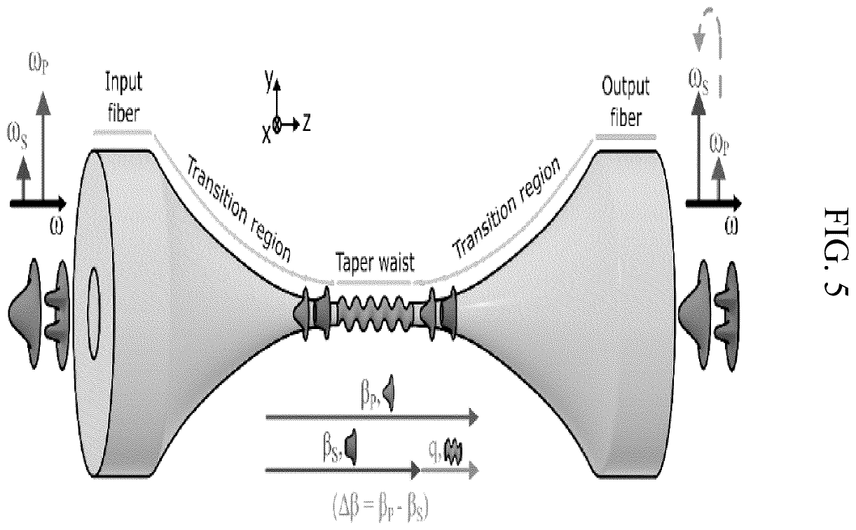

FIM-FAM is a coherent optomechanical process through which a fundamental acoustic mode with frequency Ω and wavevector q mediates parametric coupling between two distinct optical spatial modes (pump with frequency wp and wavevector βₚ, and Stokes with frequency Ωₛ and wavevector βₛ). For coupling to occur, the interaction must satisfy phase matching (Δβ=βₚ−βₛ=q) and energy conservation (Ω=ωₚ−ωₛ). These conditions can be succinctly expressed graphically by examining the acoustic dispersion lines (q((Ω)) and the difference in optical wavevectors between the two optical modes, Δβ (FIG. 4).

In this circumstance, interactions are possible at the frequencies where these lines intersect. Intermodal Brillouin interactions of this type allow for stimulated gain, single-sideband amplification, and non-reciprocal processes because of distinct phonon modes mediating Stokes and anti-Stokes processes. In addition, because the interaction frequency is determined by Δβ, by engineering the differential effective index of the participating optical modes, Δβ, the frequency of the interaction, Ω, can be tuned. However, as illustrated in FIG. 4, when changing Δβ for the higher-order modes, the frequency remains close to its q=0 value, which is fixed by the geometry. In contrast, with the fundamental acoustic modes, there is no low-frequency cutoff, and all frequencies become available. FIM-FAM, therefore, offers a wide new window of opportunity for traveling-wave optomechanical interactions (see also Xu et al., Optica, Vol. 10, No. 2, pp. 206-213, February 2023, incorporated herein by reference).

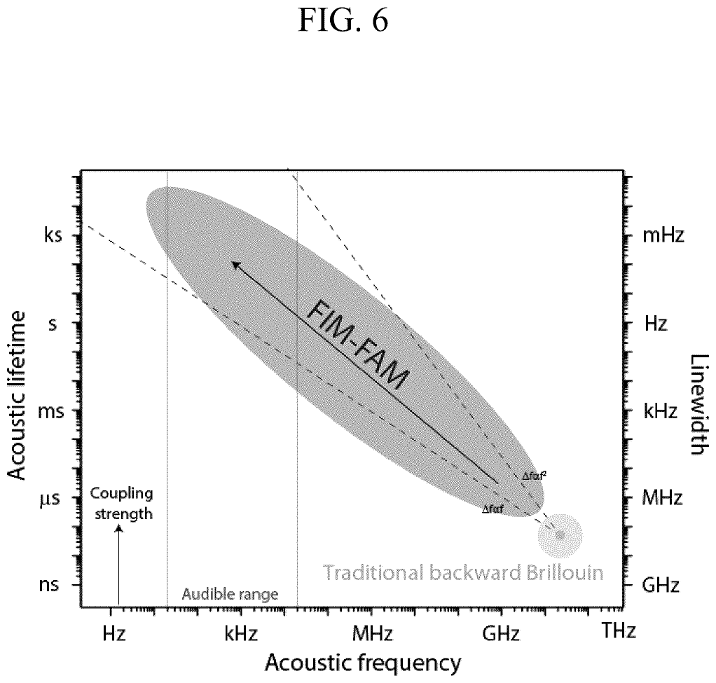

If strong optical coupling can be achieved with the frequency-agile fundamental acoustic modes (see FIG. 5), this versatile optomechanical interaction can enable unexpected access to simultaneous strong coupling and the narrow linewidths associated with lower frequency modes (FIG. 6). However, novel device design techniques are required to achieve strong confinement of acoustic waves with the long wavelengths needed for large acoustic lifetimes (see discussion below).

### FIM-FAM Interactions in a Fiber Taper

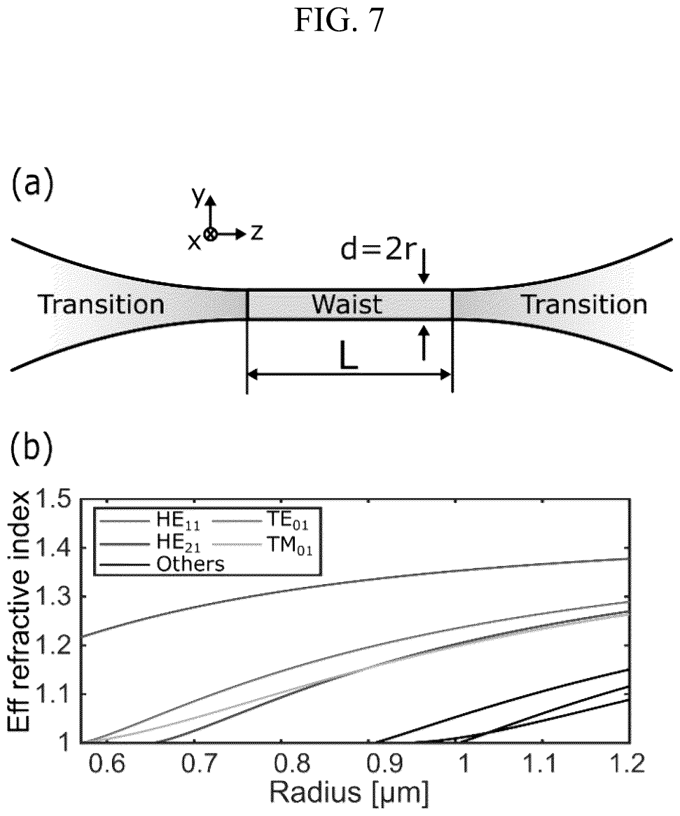

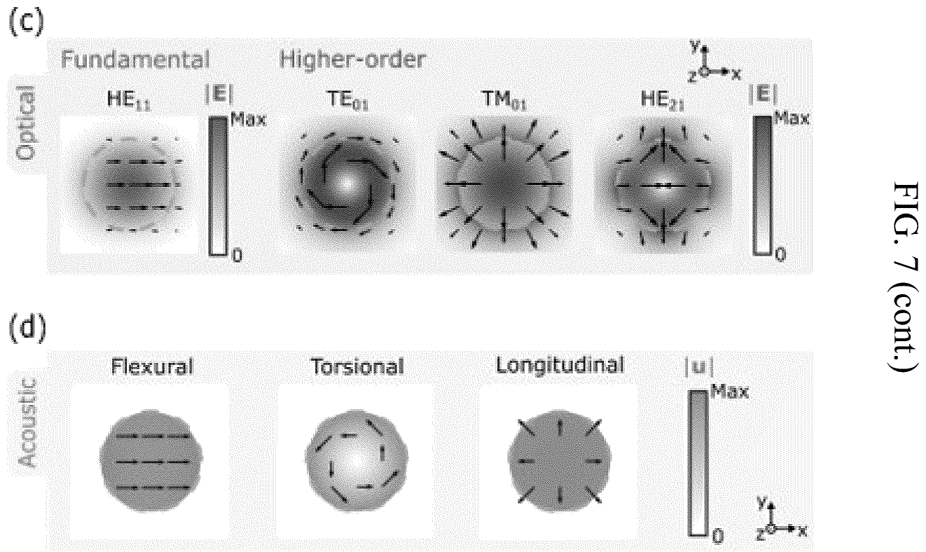

For FIM-FAM, distinct optical modes are required to mediate intermodal interactions. Light is confined in the waist of the optical taper through total internal reflection at the air-glass boundary. The optical modes are calculated by modeling the fiber taper as a uniform silica cylinder between two transition regions (FIG. 7, Panel a). The Brillouin-active waist region (FIG. 7, Panel a) is characterized by diameter d and length L. The number of optical modes supported by this structure is determined by the normalized frequency,

$$V = \frac{2 π r}{λ} \sqrt{{n}_{s}^{2} - {n}_{a}^{2}} ,$$

where r=d/2 is the taper radius, λ is the optical wavelength, nₛ is the refractive index of fused silica, and nₐ is the refractive index of air. The dispersion curves for the optical modes are calculated using a standard step-index waveguide analysis for the waist as a function of radius (FIG. 7, Panel b). Constraining the taper radius to between 570 nm and 900 nm ensures that exactly two optical mode families are guided in the waist of the taper: the fundamental mode (HE₁₁), and three higher-order modes (TE₀₁, TM₀₁, and HE₂₁ for r>650 nm). The spatial electric field distribution for the fundamental and the higher-order optical modes is illustrated in FIG. 7, Panel c.

FIM-FAM coupling strength can now be quantified through the vectorial overlap of the optical forces with the acoustic mode displacement. The relevant optical forces are electrostriction within the taper, and electrostriction and radiation pressure on the surface of the taper. While non-zero coupling is found for a variety of combinations of optical and acoustic modes, for the lowest order optical and acoustic modes calculated herein, the strongest interactions occur between the fundamental optical mode (HE₁₁), one other higher-order optical mode (TE₀₁, TM₀₁ or HE₂₁), and the fundamental flexural acoustic mode.

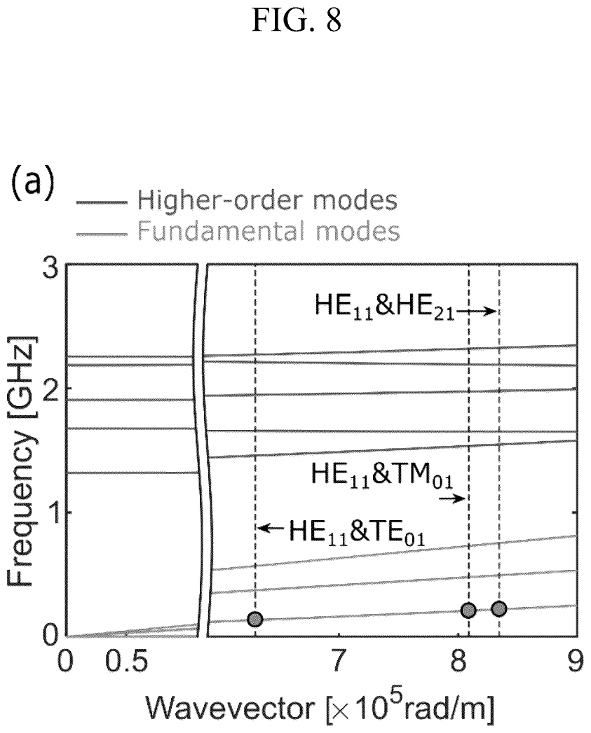

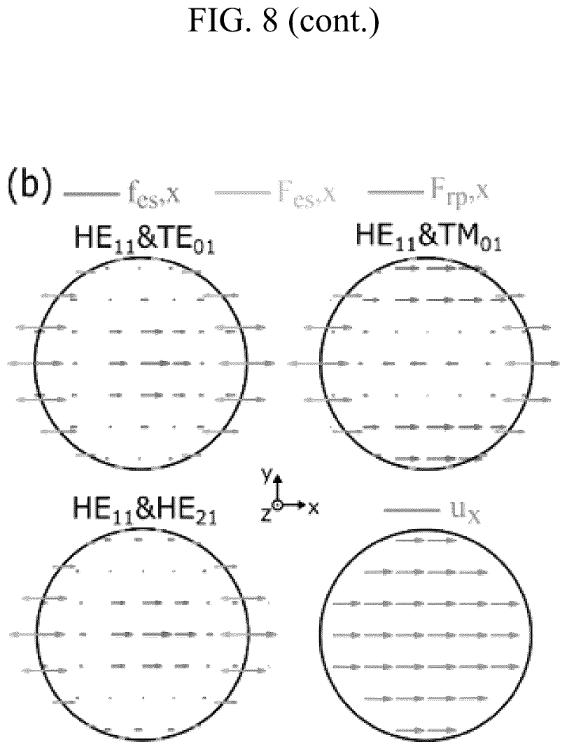

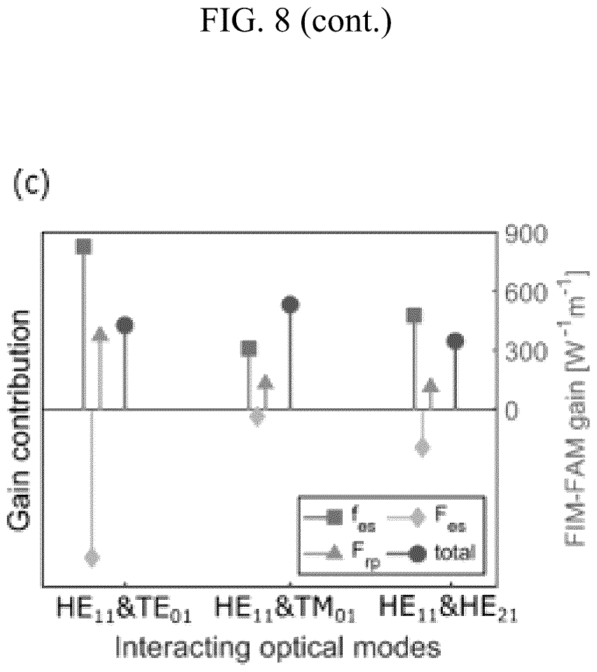

The differential index, Δβ, between the fundamental optical mode and each of the three higher-order optical modes is plotted with the acoustic dispersion curves indicating three distinct optomechanical interactions with the fundamental flexural acoustic mode (FIG. 8, Panel a). Using the calculated optical forces for each of the three higher-order optical modes (FIG. 8b) and the fundamental flexural acoustic mode with an assumed linear polarization in the x-direction (FIG. 8, Panel b), the total coupling strength is found to be 428 W⁻¹m⁻¹, 532 W⁻¹m⁻¹, and 347 W⁻¹m⁻¹ for acoustic frequencies 134 MHz, 209 MHz, and 220 MHz, through interactions with higher-order optical modes TE₀₁, TM₀₁, and HE₂₁, respectively. Note that the three optical forcing mechanisms play comparable roles, and the interference between the forces is substantial (FIG. 8, Panel c). For example, the electrostrictive surface forces counteract radiation pressure and electrostriction within this taper (note the sign of the integrated contributions in FIG. 8, Panel c). The coupling strength is calculated assuming a quality factor of Q=2000, which is typical of acoustic modes in silica at comparable frequencies. For these FIM-FAM interactions, therefore, the phonon lifetime is long (>1 μs) with large coupling strengths >300 W⁻¹m⁻¹. Note that in the same taper geometry, conventional intermodal interactions with higher-order acoustic modes only exist at frequencies above 1.5 GHZ, highlighting the unexpected utility of FIM-FAM for accessing a wide new range of phonon frequencies with longer lifetimes than previously available.

In the FIM-FAM measurement, only the FIM-FAM sideband that is phase-matched to the probe and the acoustic wave generated by the two acoustic drives will be excited. By altering the propagation direction of the driven acoustic wave, either the Stokes sideband at a lower frequency than the probe or the anti-Stokes sideband at a higher frequency than the probe. When the drive 1 is placed at a higher frequency compared to the drive 2, the driven acoustic wave co-propagates with the probe, exciting only the anti-Stokes sideband. On the contrary, when the drive 1 is placed at a lower frequency compared to the drive 2, the driven acoustic wave counter-propagates with the probe, exciting the Stokes sideband instead. To measure the single-resonance FIM-FAM responses, light coupled from the LP₁₁ mode of the two-mode fiber is preferred to be coupled into only one higher-order mode, either the TE₀₁ or TM01 mode inside the taper waist. The LP₁₁ fiber mode is a degenerate mixture of the TE₀₁, TM01 and HE₂₁ modes, where the relative ratio among three non-degenerate modes is determined by the input state of the LP₁₁ mode right before the input transition region. This input state is determined by the mode state at the output of the mode selective coupler, and the evolution of the LP₁₁ mode from the mode selective coupler to the few-mode taper. Since the HE₂₁ mode is unguided at the taper waist, the optical power of only one of the TE₀₁ and TM01 mode needs to be minimized for single-resonance FIM-FAM responses. To suppress the unwanted higher-order mode as much as possible, the state of the LP₁₁ mode at the coupler output is first altered by changing the input polarization state of the port 2 in the input single-mode fiber with a manual polarization controller PC₂ [Riesen et al., IEEE J. Quantum Electron. 48, 941-945 (2012); Love et al, Opt. Lett. 36, 3990 (2012)]. The mode evolution from coupler to the fiber taper is then adjusted with another polarization controller PC₃. The polarization controller PC₃ is used to control the polarization of the fundamental HE₁₁ mode at the taper. The polarization controller PC₄ is used to maximize the beating signal strength at the spectrum analyzer by aligning the local oscillator to be at the same polarization state as the FIM-FAM signal at the detector. These four polarization controls provide sufficient control of the optical modes involved in the FIM-FAM process for the FIM-FAM measurements.

### A Multi-Mode Optical Fiber

An aspect of the application is a multi-mode optical fiber taper for forward inter-modal Brillouin scattering with fundamental acoustic modes (FIM-FAM), comprising: a first multi-mode fiber section having a first radius; a second multi-mode fiber section having a second radius; an axially homogeneous waist section having a third radius, wherein the third radius is smaller than the first radius and the second radius; a first tapered transition section adiabatically connecting the first multi-mode fiber section to the waist section; and a second tapered transition section adiabatically connecting the waist section to the second multi-mode fiber section.

In certain embodiments, the first multi-mode optical fiber is a two-mode optical fiber.

In certain embodiments, the third radius is in a range of 570 nm-900 nm.

In certain embodiments, the first multi-mode optical fiber is able to carry more than two optical modes.

In certain embodiments, the first multi-mode optical fiber is a three-mode optical fiber.

In certain embodiments, the third radius is in a range greater than 900 nm.

In certain embodiments, the axially homogeneous waist section has a uniform radius across the waist section with a precision of no more or no less than 10 nm.

In certain embodiments, further comprising: an air-material boundary or vacuum-material boundary for at least the waist section of the taper.

In certain embodiments, the optical fiber taper is composed of a material selected from one of the group comprising: fluorozirconate, fluoroaluminate, chalcogenide, sapphire and silicon

In certain embodiments, the first radius is equal to the second radius.

In certain embodiments, a first optical mode and a second optical mode pass through the first tapered transition section, the axially homogeneous waits section, and the second tapered transition section with a greater than 75% transmission for the first optical mode, and a greater than 10% transmission for the second optical mode.

### A System of Generating a Brillouin Signal Resonance Response

Another aspect of the application is a system of generating a Brillouin signal resonance response by forward inter-modal Brillouin scattering with fundamental acoustic modes (FIM-FAM), comprising: the multi-mode optical fiber taper as described herein; a plurality of polarization controllers optically connected to the first multi-mode fiber section of the taper.

In certain embodiments, further comprising: a mode selective coupler optically connected to the first multi-mode fiber section of the taper, wherein said mode selective coupler couples at least a first optical mode to a second optical mode to become coupled optical modes within the first multi-mode fiber section.

In certain embodiments, the mode selective coupler is selected from one of the group comprising: a mode converting device, a spatial light modulator, an on-chip mode splitter or a photonic lantern.

### A Method of Generating a Brillouin Signal Resonance Response

Another aspect of the application is a method of generating a Brillouin signal resonance response by forward inter-modal Brillouin scattering with fundamental acoustic modes (FIM-FAM), comprising the steps of: generating a first optical mode in a first optical fiber, wherein the first optical mode is a fundamental optical mode; generating a second optical mode in a second optical fiber, wherein the second optical mode is a higher-order optical mode; coupling through a mode selective coupler the first optical mode to the second optical mode to become coupled optical modes; controlling through a plurality of polarization controllers polarization of the coupled optical modes; transmitting the coupled optical modes within an input multi-mode optical fiber, wherein the input multi-mode optical fiber is connected to said plurality of polarization controllers; driving a fundamental acoustic mode in a multi-mode optical fiber taper as described herein, wherein the coupled optical modes enter the multi-mode optical fiber taper from the input multi-mode optical fiber taper; wherein at least one Brillouin signal resonance response is generated within the multi-mode optical fiber taper.

In certain embodiments, a single Brillouin signal response is generated within the multi-mode optical fiber taper.

In certain embodiments, more than one Brillouin signal response is generated within the multi-mode optical fiber taper.

In certain embodiments, the fundamental acoustic mode is flexural.

In certain embodiments, the fundamental acoustic mode is torsional.

In certain embodiments, the fundamental acoustic mode is longitudinal.

From the FIM-FAM taper herein, the study demonstrated 3-dB linewidths of the FIM-FAM responses around 100-300 kHz, with the narrowest one being as narrow as only 110 kHz. The ultranarrow optomechanical linewidth achieve in this few-mode fiber taper originates from the combination of low frequency FIM-FAM resonances, great geometric homogeneity from the new fabrication technique, and the right average radius near the dispersion-less value. The ultranarrow linewidth traveling-wave optomechanical systems can lead to direct improvements on the performance of certain optomechanical applications like microwave photonic filters, where precise filters require narrow linewidths of the optomechanical sidebands. With a FIM-FAM frequency at ˜200 MHz and an assumed quality factor of 2000, the intrinsic acoustic linewidth is around 100 kHz, close to the minimum measured 3-dB linewidth. The assumed acoustic quality factor is based on FIM-FAM results on the same fiber taper platform. Further narrowing of the FIM-FAM linewidth relies on both reducing the intrinsic acoustic linewidth and minimizing the spectral broadening induced by the phonon self-interference. The intrinsic acoustic linewidth depends on both the resonance frequency and the propagation loss of the acoustic wave.

The present application is further illustrated by the following examples that should not be construed as limiting. The contents of all references, patents, and published patent applications cited throughout this application, as well as the Figures and Tables, are incorporated herein by reference.

### EXAMPLES

### Example 1: Design, Fabrication and Characterization

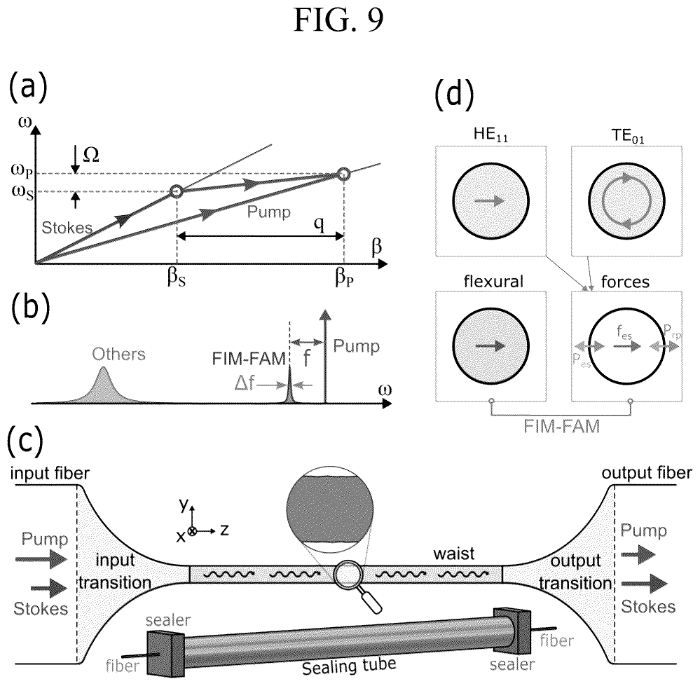

FIM-FAM occurs between the co-propagating strong optomechanical pump (frequency ω_{P}, wavevector β_{P}) and the weak optomechanical probe (frequency ωₚᵣ, wavevector βₚᵣ), each guided in separate spatial optical modes, and is mediated by the fundamental acoustic wave (frequency Ω, wavevector q). The Stokes (anti-Stokes) process corresponds to when the probe frequency ωₚᵣ is smaller (larger) that the pump frequency @p. The optical wavevectors are proportional to the effective refractive indices n_{eff} of the guiding optical modes as β=2πn_{eff}/λ, where A is the free-space wavelength. In the Stokes process, assuming the pump is guided in a mode with a larger effective index than the probe, the energy conservation and phase-matching conditions require that ω_{P}=ωₚᵣ+Ω and β_{P}=βₚᵣ+q, so that the mediated acoustic wave travels in the same direction as the pump and probe (FIG. 9, Panel a). Otherwise, when the probe is guided in the larger effective index mode instead, β_{P}=βₚᵣ−q and the mediated acoustic wave travels in the opposite direction as the light. Due to the non-cutoff nature of the fundamental acoustic modes combined with the small phase-matched acoustic wavevector realized by FIM-FAM, the FIM-FAM frequency can be significantly lower than that of other types of Brillouin interactions, resulting in a much narrower Brillouin linewidth (FIG. 9, Panel b).

The design and fabrication of the few-mode fiber taper samples targets a high-performance single-resonance FIM-FAM platform achieving narrow linewidth and strong optomechanical signal. In a fiber taper, light propagating in the input fiber is coupled into the waist region, where the radius is much smaller, through a transition region with progressively decreasing transverse size. After the taper waist, light is then coupled into the output fiber via the output transition region with increasing transverse size instead. FIM-FAM is engineered to occur in the waist region of the taper among the fundamental optical mode, one of the higher-order optical modes, and the fundamental flexural acoustic mode. Since different higher-order optical modes have distinct effective indices, the number of FIM-FAM resonances is determined by the number of guided higher-order modes at the taper waist, which positively correlates with the normalized frequency

$$V = \frac{2 π r}{λ} \sqrt{{n}_{co}^{2} - {n}_{cl}^{2}} .$$

Here, r is the waist radius, n_{co}=1.444 is the refractive index of the fused silica, and n_{cl}=1 is the index of the air cladding. To achieve single-resonance FIM-FAM, the few-mode fiber taper is designed to be made from a stepped index two-mode fiber supporting only the fundamental LP₀₁ and higher-order LP₁₁ modes. In the input transition region, light in the LP₀₁ fiber mode evolves into the fundamental HE₁₁ waist mode, and light in the LP₁₁ fiber mode gradually couples into a combination of the higher-order TE₀₁, TM₀₁ and HE₂₁ waist modes (FIG. 9, Panel c). In work, the waist radius was approximately 830 nm, which allowed all three higher-order optical modes to be guided at the waist region, resulting in three distinct FIM-FAM resonances and making it difficult to achieve a single FIM-FAM resonance. Here, the normalized frequency V is designed to be within the range of (2.405, 2.756), corresponding to a waist radius between 570 nm and 650 nm, only two higher-order TE₀₁ and TM01 modes will be well guided by the taper waist, while light in the HE₂₁ mode dissipates into the air by the end of the input transition region. If light undesirably coupled into either one of the TE01 and TM01 modes can be further suppressed with delicate mode controls at the input of the fiber taper, single-resonance FIM-FAM responses can be individually achieved. The final waist size is designed to be 600 nm to accommodate potential fabrication uncertainties.

The achievable FIM-FAM linewidth in the fiber taper system is limited by both the intrinsic acoustic linewidth and the axial geometrical inhomogeneity of the waist region. The intrinsic acoustic linewidth is determined by the propagation loss of the mediated acoustic wave. In homogeneous taper waists with no axial geometrical variations on the cross-sections, the FIM-FAM linewidth equals to the intrinsic acoustic linewidth. However, fabrication imperfections introduce axial variations in the local waist radius, resulting in geometric inhomogeneity of the waist region. As has been discussed for backward and forward intra-modal Brillouin systems with short-lived phonons, as well as for FIM-FAM systems with long-lived phonons, geometric inhomogeneity in Brillouin-active waveguides introduce frequency shifts on local Brillouin resonances, which then result in the spectral broadening of the Brillouin linewidth on top of the intrinsic acoustic linewidth. In the few-mode fiber tapers, the variation of the local waist size alters the effective refractive indices of both optical modes of the pump and probe, which then influences the phase-matched acoustic wavevector of the mediated acoustic wave. In addition, the phase velocity of the mediated wave also depends on the local waist radius. The FIM-FAM resonant frequency then has a complicated dependence on the local radius. To minimize axial variations in the local FIM-FAM frequency, the waist region should be as homogeneous as possible. This can be achieved by designing the waist radius to remain uniform and optimizing the fabrication process to reduce deviations introduced during production.

On the other hand, the total FIM-FAM strength from the fiber taper is determined by the total optomechanical gain G as G=G_{OM}PₚL, where G_{OM} is the optomechanical gain coefficient determined by the transverse distributions of the interacting optical and acoustic modes, Pₚ is the optical power of the Brillouin pump, and L is the interaction length. At the taper waist, optical and acoustic modes are all tightly confined by the silica-air boundary with a large gain coefficient G_{OM}. For FIM-FAM in few-mode fiber tapers, the optomechanical gain coefficient can be calculated with the vectorial overlap on the cross-section between the optical forces generated by the two optical modes, and the displacement field of the phase-matched fundamental flexural mode (FIG. 9, Panel d). The distributions of the HE11, TE01 and TM01 modes are first numerically simulated, along with their effective refractive indices. The distributions of three kinds of optical forces, including the bulk electrostriction inside the taper, and the surface electrostriction as well as the radiation pressure on the surface of the taper, are then calculated from the electrical fields of the HE11 mode and either one of the TE01 and TM01 modes. The resonant frequencies and the displacement fields of the fundamental flexural mode for the HE11-TE01 and HE11-TM01 interactions are numerically simulated with phase-matched acoustic wavevectors. Finally, the force-displacement overlap is then integrated over the entire cross-section, to calculate the final optomechanical gain coefficient G_{OM}. The power of the Brillouin pump PP at the waist region can be increased by either increasing the input power from the input fiber or improving the optical transmission of the input transition region. In addition, the probe propagating in the other optical mode also requires minimal insertion loss throughout the whole fiber taper for maximum optical power at the output. The symmetric input and output transition regions are then designed to be low loss for the fundamental and higher-order optical modes with a 35 mm axial length for each region. A waist region as long as 100 mm is put into the final design to enhance the interaction length L. The lengths of the transition and waist regions are practically constrained by gravity-induced sagging at the center and the maximum taper length allowed by the fabrication setup.

The heat-brush technique, a fabrication method well known for its versality to achieve customized fiber taper profiles, is suitable for creating fiber tapers with long and homogeneous taper waists, as well as long transition regions with profiles targeting high optical transmissions. During the fabrication, an hydrogen-oxygen flame heats the center of the taper, while two translation stages holding two fiber ends shape the taper profile by moving along the traces calculated with an adapted version of the algorithm targeting ultra-low-loss single mode fiber tapers.

### Taper Fabrication

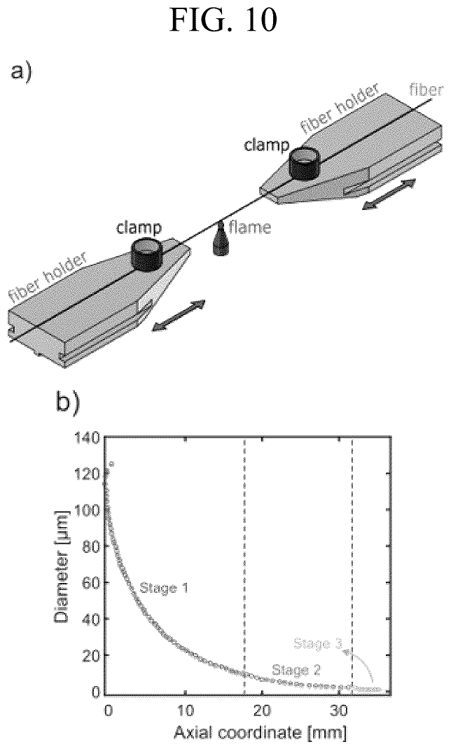

The fiber taper samples are fabricated with the heat-brush technique, which is known for its flexibility and reproducibility in creating fiber tapers with customized transition and waist profiles. To fabricate the taper a two-mode fiber is fixed by two fiber holders (FIG. 10a) mounted on electrically controlled motorized stages. During fabrication, a stationary hydrogen-oxygen flame heats the fiber while the fiber moves along a preprogrammed trajectory. The taper is designed to have a 100 mm long uniform waist with two symmetrical ˜35 mm long transition regions either side (FIG. 10, Panel b). The waist length is limited by sagging at its center due to gravity, as well as the movement range of the translation stages. The design of the taper profile and the stage trajectory algorithm are adapted from previous work demonstrating near unity transmission single-mode fiber tapers. The transition region consists of three segments, but using exponential tapering instead of linear to ensure smoother transitions and to increase the likelihood of successful fabrication. This method, originally developed for tapering single-mode fibers, had to be adapted for two-mode fibers, with the key challenge being to maintain adiabatic transitions for the higher-order LP11 mode. Numerical calculations indicated that the most suitable taper profile for LP11 mode transmission features the steepest slope for diameters between 45 μm and 25 μm. To achieve this, the slope of the first exponential curve was designed using a large number of points to precisely control the diameter reduction within this range. The second exponential segment begins only at a 10 μm diameter, allowing for attenuation that continues through the third exponential phase, which ensures uniformity of the waist diameter. The output transition region matches the input region such that the taper is symmetric. The stage trajectory algorithm takes the transition region profile for an input and calculates the instantaneous speed and acceleration of the two translation stages as a function of fabrication time before passing these values to the stages during fabrication. As a result, the fiber is heated and elongated until the designed taper profile is realized by the end of the fabrication. The exponential decay constants for each segment are optimized to maximize the overall transmission of the LP₀₁ modes while keeping the length of each section short such that the overall taper length remains within the axial movement length limits of the translation stages.

### Post-Fabrication Taper Profile Characterization

After the initial geometry characterizations, the taper samples are first slightly stretched in the axial direction to maintain the complete taper profile, then glued at the fiber sections on both ends on top of a specifically designed 3D-printed support. The sample with the bottom support is then put into a stainless-steel sealing tube and sealed on both ends with two 3D-printed sealers to fix the relative movements between the sealing tube and the taper sample (FIG. 9, Panel c inset). After the packaging process, the taper samples were investigated for further transmission characterizations and FIM-FAM measurements.

Taper characterizations with backward optomechanical measurements and the optical backscattering reflectometry reveal that the lengths of the waist region and the transition regions are close to the designed values at 100 mm and 35 mm respectively. The waist radius stays around 615 nm within the target range guiding only the HE₁₁, TE₀₁ and TM₀₁ modes.

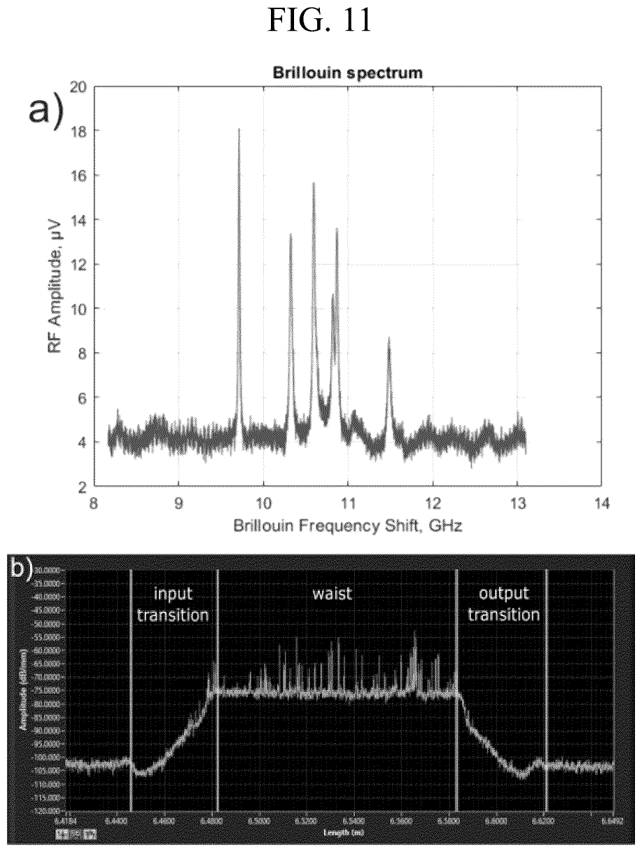

After fabrication and before shipping the taper is analyzed with transmission measurements, backward Brillouin spectroscopy, and high resolution non-destructive optical backscattering reflectometry. Transmission of the LP₀₁ mode is measured by the transmitted power of a laser input into a single-mode fiber which seeds the fundamental mode of the subsequently spliced to the two-mode fiber used for the taper. Measurements before and after tapering are compared. The initial value for optical transmission is as high as 98%, higher than the ˜82% transmission measured before the FIM-FAM measurements at Rochester, possibly due to the undesired taper deformation from the axial tightening during the packaging and random displacements within the package during the transformation. Backward Brillouin spectroscopy is used to estimate the waist radius of the fiber taper. The waist radius measured through this technique is estimated to be ˜615 nm (FIG. 11, Panel a). Finally, high resolution non-destructive optical backscattering reflectometry measurements is used to determine the axial length each region of the taper, including the input transition region, the waist region and the output transition region. The resultant waist length is found to be around 100 mm and the lengths of the transition regions are around 35 mm, close to the designed values (FIG. 11, Panel b).

At this waist radius, the effective indices of the simulated optical modes are 1.24 (HE11), 1.03 (TE01) and 1.01 (TM01). The acoustic wavevectors of two interactions are then calculated with typical mechanical properties of the fused silica, with FIM-FAM frequencies at ˜189 MHz for the TM₀₁ resonance and ˜210 MHz for the TM₀₁ resonance. At the simulated resonances with the assumed acoustic quality factor of 2000, the Brillouin gain of the TM₀₁ resonance is calculated as 506 W⁻¹m⁻¹, and the TM₀₁ resonance has a gain of 361 W⁻¹m⁻¹. On the fabricated taper sample, the optical transmission of the fundamental LP₀₁ (HE₁₁) mode is measured to be ˜82%, and the transmissions of the TM₀₁ and TM₀₁ mode are measured to be >3.6% and >4.0% respectively, with the uncertainty coming from the amount of power coupled into the unguided HE₂₁ taper mode that cannot be directly measured. The homogeneity of the taper waist is excellent for narrow linewidth FIM-FAM demonstration, with maximum fluctuation of the waist radius at only ˜2.5% around the average value measured from forward intramodal optomechanical measurements with the fundamental mode.

Waist Radius Characterization with Forward Intra-Modal Optomechanical Measurements

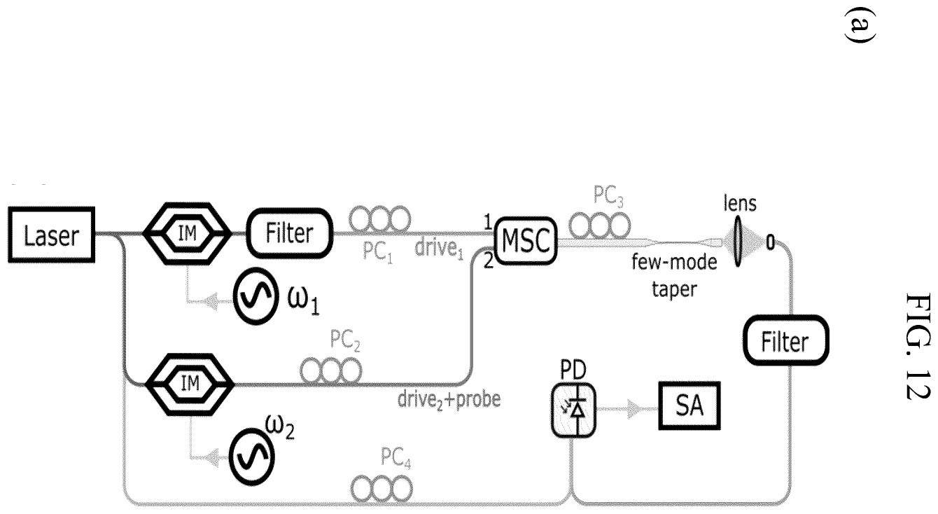

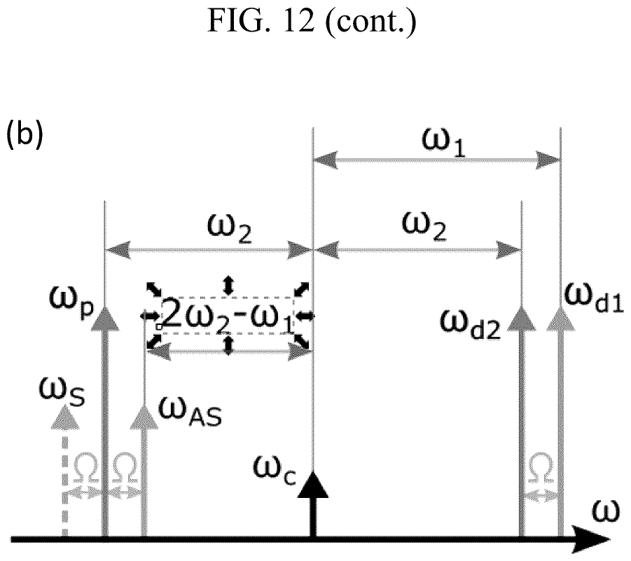

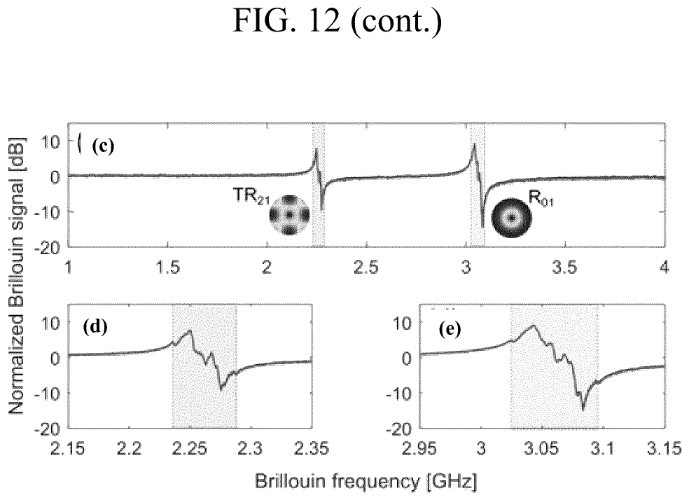

The taper sample is characterized for waist homogeneity with measurements of forward intra-modal Brillouin scattering. Since forward intra-modal scattering excites higher order acoustic modes with high frequencies that have larger dissipation than the low-frequency FIM-FAM modes, the spectral response is not complicated by phonon self-interference and can be used to extract information about the geometry of the taper. For example, because the driven higher order modes are accessed near their cutoff frequencies which are fixed by the waist radius, the waist radius can be extracted from measurements of the intra-modal Brillouin response frequency. Furthermore, variations in this frequency correspond to variations in the waist radius and therefore give information about the taper homogeneity. The forward intra-modal response for the HE₁₁ mode of the FIM-FAM fiber tapers are measured with an experimental setup similar to that designed for the FIM-FAM measurements (a). In contrast to the FIM-FAM measurement configuration, however, both the acoustic drives and the probe are all coupled into the fundamental HE₁₁ mode of the taper waist via the mode selective coupler. Theoretical predictions for the optomechanical gain using optical and acoustic modes simulated with an FEM solver for a 630 nm taper radius reveal high gain for two higher-order acoustic modes, the TR₂₁ mode at 2.20 GHz and the Roi mode at 2.97 GHz. Experiments likewise show two optomechanical resonances (FIG. 12, Panel c). The measured resonance frequencies correspond to a radius of 612 nm, which is almost identical to the 615-nm radius extracted from backward optomechanical measurements before the packaging (previous section).

As expected, the resonant features have a Fano-like structure because the strength of the Brillouin signal is comparable to the frequency independent background (which partially originates from intra-modal Kerr four-wave mixing). The resonance frequencies will exhibit inhomogeneous broadening due to the axial inhomogeneity of the waist radius, with complicated structure due to the interference with the background nonlinearity. From the overall ˜2.5% frequency variation of the measured resonances and their upper and lower frequency bounds, the waist radius is estimated to have a maximum variation of ˜15 nm in the taper waist region, from 604 nm to 619 nm.

### Example 2: Measurement and Results

FIM-FAM is measured with a phonon-mediated four-wave mixing spectroscopy approach based on sensitive Brillouin spectroscopy techniques. With the four-wave mixing technique, two optical drive tones generate an acoustic wave in the optomechanical device, and a third tone at a distinct frequency probes the driven acoustic wave which scatters to generate a fourth tone that is sensitively measured with heterodyne detection. The first acoustic drive, drive 1 (ω_{d1}=ω_{c}+ω₁), is generated with a null-biased intensity modulator modulating carrier frequency, ω_{c}, with frequency ω₁, with three fiber Bragg grating (FBG) filters used to suppress the unwanted modulator's lower frequency sideband. Drive 1 is then input into port 1 of a mode selective coupler (MSC) which couples to the fundamental mode (HE₁₁) of the fiber taper, which is fusion spliced to the MSC's output two-mode fiber. Drive 2 (ω_{d2}=ω_{c}+ω₂) and the probe (ωₚᵣ=ω_{c}−ω₂) are generated from the same laser (ω_{c}) with another null-biased intensity modulator driven at frequency ω₂ (ω₂<ω₁) and both are input into port 2 of the MSC which couples to the higher-order TE₀₁ and TM₀₁ modes of the fiber taper. When the frequency difference of two acoustic drives matches the FIM-FAM resonant frequency of the taper (ω_{d1}−ω_{d2}=Ω), a fourth tone, the anti-Stokes sideband (it would be Stokes if ω₂>ω₁ instead see discussion of FIM-FAM measurements with four different optical and acoustic configurations) of the probe, scatters into the fundamental optical mode from the fundamental flexural acoustic wave generated by the drive tones. The resultant anti-Stokes FIM-FAM signal (as well as residual drive 1) in the fundamental mode efficiently couples into the single mode of the receiving fiber collimator, while both the drive 2 and probe in the higher-order modes are strongly rejected due to their orthogonal mode symmetry. After two FBG filters rejecting residual light from the drive tones, the signal couples into a photodetector with an additional local oscillator derived from the carrier frequency, ω_{c}, to generate the RF signal for a signal analyzer. Due to bias drift and the non-ideal performance of the null-biased intensity modulator located before port 2 of the MSC, a small residual amount of carrier leakage can occur. This leakage allows a portion of the optical carrier to enter the few-mode taper, accompanying both drive 2 and the probe. Since this leaked carrier is spectrally separated from the optical tones participating in the FIM-FAM, it does not contribute to the interaction. It is then filtered out by the FBGs after the collimator before the heterodyne detection. To acquire the FIM-FAM spectral response, the acoustic drive frequency, ω_{d1}−ω_{d2}=ω₁-ω₂, with ω₁ fixed is swept by sweeping ω₂ through the resonance frequency, Ω, while tracking the RF signal at the corresponding beat frequency (2ω₂-ω₁) (FIG. 12, Panel b).

Four polarization controllers are placed throughout the setup (see FIG. 12, Panel a) to optimize mode coupling and the measurement strength. To obtain a single-resonance FIM-FAM response, light in the higher order mode (LP₁₁) of the MSC's output two-mode fiber must couple into only one higher-order mode of the fiber taper (i.e. only TE₀₁ or only TM₀₁). The coupling ratio between the LP₁₁ and the taper modes (TE₀₁ and TM₀₁) is determined by the polarization of the single-mode fibers input to the MSC as well as that of the LP₁₁ mode on the output of the MSC. To suppress the unwanted higher-order mode, therefore, manual polarization controllers are used to control the polarization at the input of port 2 of the MSC (PC₂) and on the MSC output fiber (PC₃). The adjustment on the polarization controller PC₃ also influences the polarization of the fundamental HE₁₁ mode in the taper. A polarization controller on the local oscillator fiber (PC₄) is used to maximize the beat signal on the spectrum analyzer through aligning the local oscillator to the polarization of the FIM-FAM response signal. To selectively excite a single FIM-FAM resonance using the HE₁₁ and TE₀₁ modes, the other resonance modes can be suppressed by maximizing the RF power of the desired response at the photodetector through adjustments of the polarization controllers PC₂, PC₃ and PC₄. In order to calibrate the transmission loss of the beat signal from the detector to the spectrum analyzer, the residual probe light that leaks into the detector, originating from the finite mode rejection of the collimator and the mode cross-coupling throughout the whole taper, is utilized. The leaked probe is aligned to the FIM-FAM signal at the collimator by adjusting the polarization of the drive 1 and FIM-FAM signal with PC₁. Since the FIM-FAM gain coefficient is insensitive to the polarization state of the HE₁₁ mode, the FIM-FAM signal strength remains unchanged during this process. By measuring the strength of the beat signal between the local oscillator and the leaked probe on the spectrum analyzer, along with the optical power of the leaked probe at the detector, the RF signal loss from the detector to the spectrum analyzer can be determined and then used to correct for the beat signal strength between the FIM-FAM signal and the local oscillator. A single FIM-FAM resonance driven by the HE₁₁ and TM₀₁ can alternatively be measured by minimizing the response from FIM-FAM driven by the HE₁₁ and TM₀₁ modes in a similar way.

### Results

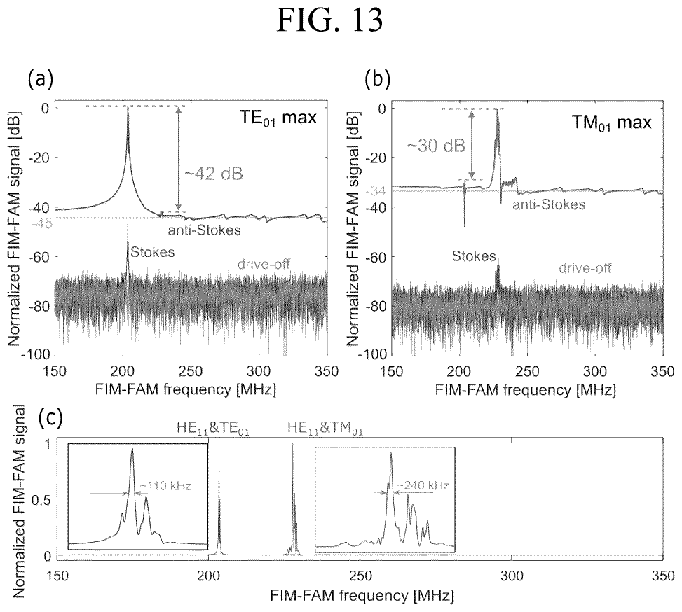

Optimized measurements of the FIM-FAM device reveal high-contrast nearly single-peaked responses with linewidths as narrow as 110 kHz and an effective gain that is nearly two orders of magnitude greater than in previous devices (FIG. 13). The anti-Stokes sideband is observed because it is phase-matched by ensuring that drive 1 is at a higher frequency than drive 2 (FIG. 13 blue and orange). In contrast, light at the Stokes frequency in this condition is >45 dB weaker (nonzero due to weak modal cross-coupling in the taper), confirming the non-reciprocity the interaction (FIG. 13 purple). A spectral response is also absent when the drive tones are off, as expected (FIG. 13 green). The anti-Stokes resonances between the fundamental mode HE11 and the two high-order modes TE01 and TM01 are observed at 203 MHz and 228 MHz respectively, which is within 10% of the predicted frequencies, deviating slightly due to the uncertainty of the mechanical properties of the material and the axial strain in the physical sample introduced in the fabrication and packaging. With optimized polarization adjustments described in the previous section, a single response corresponding to the TE01 mode is realized with >40 dB contrast compared to the remainder of the spectrum, which include the response from the TM01 mode, the Kerr four-wave-mixing background and other (non-FIM-FAM) optomechanical responses from the fiber taper and the connected two-mode fiber (FIG. 13, Panel a). Alternatively, a single-peaked response from the TM01 mode can be observed with >30 dB contrast compared to the remainder of the spectrum (FIG. 13, Panel b).

With sufficient spectral resolution, each resonance exhibits complex spectral structure owing to the small residual axial inhomogeneity of the fiber taper waist (FIG. 13, Panel c). The 3-dB linewidth of the primary peak from the TM₀₁ resonance is 110 kHz, much narrower compared to the previous FIM-FAM taper sample and other types of demonstrated high-gain traveling-wave optomechanical systems. The 3-dB linewidth of the major peak from the TM₀₁ resonance is similar but broader at 240 kHz due to both subtleties in the phonon self-interference effect and the frequency dependence of FIM-FAM as a function of the local taper radius, respectively.

The FIM-FAM gain given by P_{sig-peak}=G_{OM}PₚL can be determined for signal power of the major peaks. In four-wave mixing spectroscopy the FIM-FAM signal power is

$${P}_{sig - peak} = \frac{{G}_{OM}^{2} {L}^{2}}{4} {P}_{d 1} {P}_{d 2} {P}_{pr} ,$$

where L is the FIM-FAM active waveguide length, P_{d1} is the power of the drive 1, P_{d2} is the power of the drive 2, and Por is the power of the probe. G_{OM}×L in the unit of W⁻¹ then describes the efficiency of the entire device. With this we find that the major peak from the TE₀₁ (TM₀₁) resonance has a gain of 5.75 W⁻¹ (1.51 W⁻¹), both more than an order of magnitude larger than the previous FIM-FAM taper devices because their enhanced length and homogeneity. When used with a simple two-tone pump-probe configuration the signal would be in the fundamental mode because it has less loss than the higher-order mode—but because the higher order mode loss is reduced in this device by ˜4 times (2 times for each transition), the maximum FIM-FAM pump power at the waist is then at least twice than before. Overall, therefore, the current taper sample enables >90 times larger G_{OM}PₚL in in the previous taper-based FIM-FAM platform, a major advance for photonic applications.

The theoretical model based on the phonon self-interference effect, which describes the interference of mediated long-lived phonons with themselves during the propagation, has been introduced before to model FIM-FAM in inhomogeneous few-mode fiber tapers. It was then used to quantitatively characterize the FIM-FAM spectra and estimate the optomechanical gain coefficients. In the absence of non-destructive method to accurately measure the taper waist profile with nm-level resolutions, it is challenging to model the FIM-FAM spectra in this fiber taper sample with the slight geometrical inhomogeneity. For qualitative analysis, the histogram of the local waist radii across the whole waist region is first estimated from the experimental TM₀₁ resonance, by treating the experimental spectra with the simplified inhomogeneous broadening model neglecting the long decay length of the acoustic wave and the slight phase mismatch.

### Estimation of the Waist Profile Based on the FIM-FAM Spectrum

In order to properly further analyze the phonon self-interference, the waist profile is required to precisely model the phonon evolution and the signal propagation. However, as the taper embodiment only suffer suffers from a slight inhomogeneity within 15 nm, it is challenging to accurately measure the wait profile, even with the popular scanning electron microscopy due to the practical measurement uncertainties. In addition, destructive measurement methods will eliminate any further characterization on the few-mode fiber tapers. To non-destructively estimate the taper profile in a reasonable way, we use a simplified version of the phonon self-interference model to treat the taper embodiment by neglecting the propagating nature of the phonons, similar to previous discussions on the inhomogeneous spectrum broadening on inhomogeneous optomechanical waveguides. This is modelled by assigned

$$\frac{db ( z )}{dz} = 0$$

in Eqn. (26), anu as a result, for example in the configuration [AB]ₒ-[AB]ₐ

$$b ( z ) = \frac{{ig}_{0}^{*} ( z ) {a}_{d 1} {a}_{d 2}^{*}}{( i ( Ω - {Ω}_{0} ( z ) ) - \frac{Γ ( z )}{2} )} \qquad ( 1 )$$

$${a}_{AS} ( z ) = - \frac{{a}_{d 1} {a}_{d 2}^{*} {a}_{p}}{{v}_{o}} {\int }_{0}^{z} \frac{{\vert {g}_{0} ( ε ) \vert}^{2} ( i ( Ω - {Ω}_{0} ( ε ) ) + \frac{Γ ( ε )}{2} )}{( {( Ω - {Ω}_{0} ( ε ) )}^{2} + {( \frac{Γ ( ε )}{2} )}^{2} )} d ε \qquad ( 2 )$$

At the output, assuming that vₒ, vₒ₂, Γ are barely changing axially, the FIM-FAM signal power will be

$${P}_{AS} = ℏ {ω}_{AS} {v}_{o} {\vert {a}_{AS} ( L ) \vert}^{2} = \frac{{G}^{2} {P}_{d 1} {P}_{d 2} {P}_{pr}}{4} ( {f}_{1}^{2} ( z ) + {f}_{2}^{2} ( z ) ) \qquad ( 3 )$$

$${f}_{1} ( z ) = {\int }_{0}^{L} \frac{( Ω - {Ω}_{0} ( z ) ) \cdot \frac{Γ}{2}}{{( Ω - {Ω}_{0} ( z ) )}^{2} + {( \frac{Γ}{2} )}^{2}} dz \qquad ( 4 )$$

$${f}_{2} ( z ) = {\int }_{0}^{L} \frac{{( \frac{Γ}{2} )}^{2}}{{( Ω - {Ω}_{0} ( z ) )}^{2} + {( \frac{Γ}{2} )}^{2}} dz \qquad ( 5 )$$

Due to the narrow intrinsic FIM-FAM linewidth, the FIM-FAM response quickly declines at spectral frequencies far away from the frequencies of local FIM-FAM resonances in the waist region, making the FIM-FAM spectral range roughly the same as the frequency range of the local FIM-FAM resonances corresponding to the range of fluctuating radius in the waist region. Targeting a reasonable profile estimation base on reverse calculations extracting the information on the taper profile from the final FIM-FAM spectra, combined with the fact that f₁ is larger than f₂ when Ω is close to the local resonant Ω₀,

$${P}_{AS} \approx \frac{{G}^{2} {P}_{d 1} {P}_{d 2} {P}_{pr}}{4} {f}_{2}^{2} ( z )$$

from Eqn. (3). This simplifies the square root of the FIM-FAM signal spectrum to have a Lorentzian distribution that

$$\sqrt{{P}_{AS} ( Ω )} ∝ {\int }_{0}^{L} \frac{{( \frac{Γ}{2} )}^{2}}{{( Ω - {Ω}_{0} ( z ) )}^{2} + {( \frac{Γ}{2} )}^{2}} dz \qquad ( 6 )$$

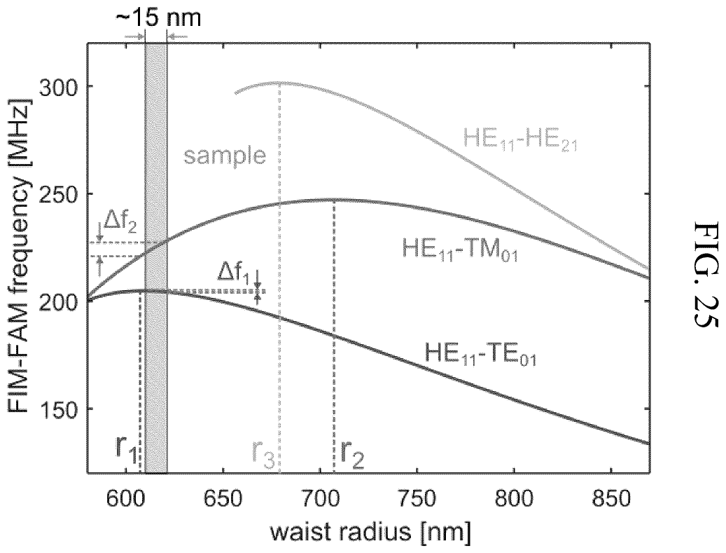

Based on FIG. 25, the embodiment waist size is close to the inhomogeneity-insensitive radius of the HE11-TE01 interaction, but far away from that of the HE11-TM01 interaction. Considering the deviation of the actual FIM-FAM dispersion curves from the theoretical ones, the HE11-TM01 interaction should still exhibit a clear trend of decreasing FIM-FAM frequency with increasing waist radius, within the variation range of the waist size. Eqn. (13) can be rewritten as

$$\sqrt{{P}_{AS} ( Ω )} ∝ {\int }_{{Ω}_{1}}^{{Ω}_{2}} \frac{{( \frac{Γ}{2} )}^{2}}{{( Ω - {Ω}_{0} )}^{2} + {( \frac{Γ}{2} )}^{2}} \frac{d [ z ( {Ω}_{0} ) ]}{d {Ω}_{0}} d {Ω}_{0} \qquad ( 7 )$$

Here, Ω₁ and Ω₂ are the lower and upper limits of the local FIM-FAM resonances across the taper waist. Eqn. (14) can then be converted into an infinite integral

$$\sqrt{{P}_{AS} ( Ω )} ∝ {\int }_{- ∞}^{∞} \frac{{( \frac{Γ}{2} )}^{2}}{{( Ω - {Ω}_{0} )}^{2} + {( \frac{Γ}{2} )}^{2}} \frac{d [ z ( {Ω}_{m} ) ]}{d {Ω}_{m}} rect ( \frac{{Ω}_{m} - \frac{( {Ω}_{1} + {Ω}_{2} )}{2}}{{Ω}_{2} - {Ω}_{1}} ) d {Ω}_{0} \qquad ( 8 )$$

Which apparently can be treated as a convolution between a Lorentzian profile and a function

$$\frac{d [ z ( Ω ) ]}{d Ω}$$

in a finite window.

$$\sqrt{{P}_{AS} ( Ω )} ∝ \frac{{( \frac{Γ}{2} )}^{2}}{{Ω}^{2} + {( \frac{Γ}{2} )}^{2}} * ( \frac{d [ z ( Ω ) ]}{d Ω} rect ( \frac{Ω - \frac{( {Ω}_{1} + {Ω}_{2} )}{2}}{{Ω}_{2} - {Ω}_{1}} ) ) \qquad ( 9 )$$

Then, with the FIM-FAM spectra the study experimentally measured from the HE11-TM01 interaction in the configuration [AB]ₒ-[AB]ₐ, we can perform a deconvolution to extract the distribution of

$$\frac{d [ z ( Ω ) ]}{d Ω} ,$$

from which z(Ω) and the corresponding Ω(z) can be calculated (a). While the estimation seems monolithic between the FIM-FAM frequency Ω and the axial location z, mathematically based on Eqn. (6), the distribution of each point on the curve can be arbitrary across the whole taper waist. As a result, the actual information offered from the deconvolution should only be a histogram of the Ω(z) at the waist region. (b) Then, the estimated histogram is thrown into a straightforward algorithm to randomly constitute three hypothetical frequency profiles matching the pre-calculated frequency histogram (c-d). It is assumed that the local radius of a practical waist profile should be randomly fluctuating mildly along the axial direction. According to c, the thought process for this algorithm can be broken down into the following steps:
Monotonic Ω(z) generation: A monotonically increasing Ω(z) curve containing M points is generated from the histogram of Ω(z).
Nodes selection and arrangement: A set of N nodes (N=50 as a reasonable assumption) representing the locations with zero local slope, and the two endpoints of the waist region along the taper profile, is selected from M points. These N nodes are then randomly distributed along the axial direction within the waist.
Slots definition and selection: With N axial nodes, N−1 slots are defined, each covering the range of axial locations between two adjacent nodes. For the remaining M-N points after the node selection process, each point is randomly assigned to a slot, and the axial length of each slot is then determined by the number of points it contains.
Monotonic points arrangement: Since the nodes correspond to locations with zero local slope, the radius of the points should either monotonically increase or decrease within each slot, the trend of which is determined by the relative radius difference of the two nodes. The points within each slot are then monotonically arranged accordingly.
The algorithm with randomness is run repeatedly to generate different hypothetical curves.

Since the local resonance Ω₀ has a simple dependence on the local taper radius r, Ω(z) carries the information about r(z), which physically represents the distribution of the local taper radius as a function of the axial location. As the waist length and the variation of waist radius have been measured from previous characterizations, three estimated waist profiles can be derived from the hypothetical frequency profiles to be utilized in further phonon self-interference analysis (FIG. 15, Panel d).

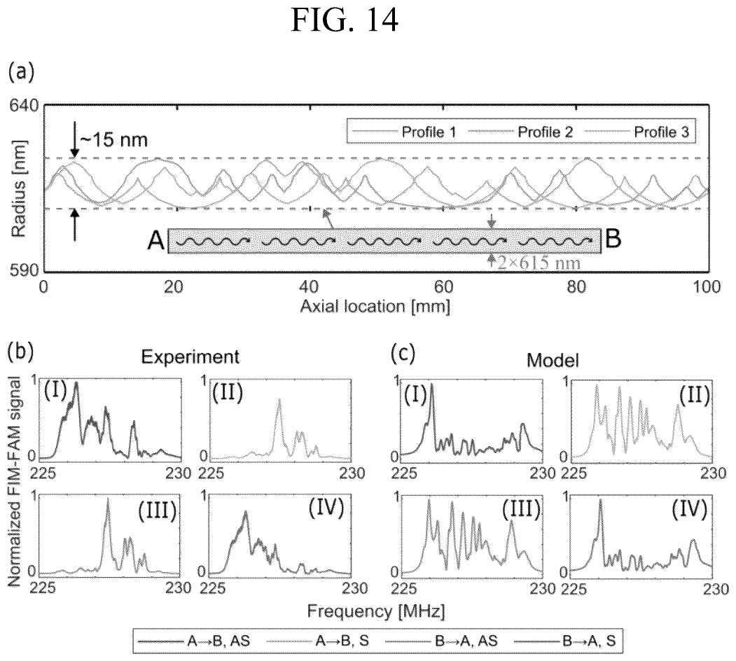

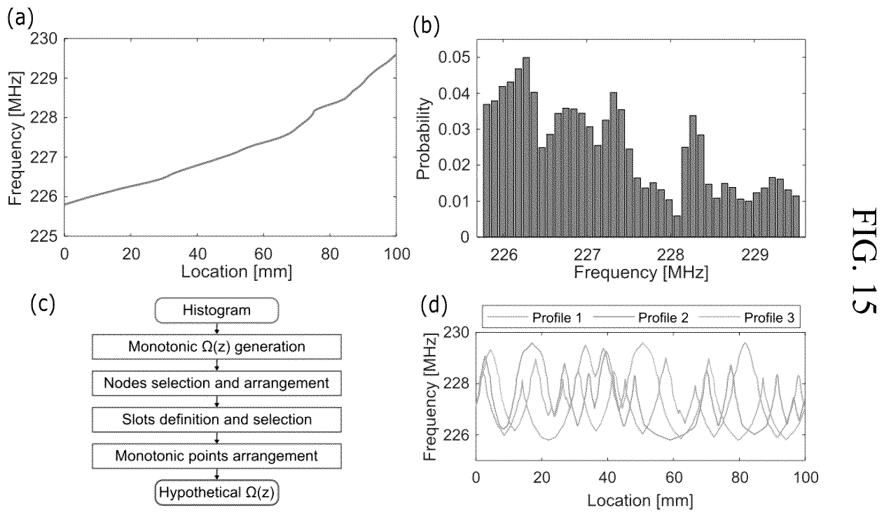

Three hypothetical profiles 1, 2 and 3 are then generated from the histogram (FIG. 14, Panel a), which can then be put into the phonon self-interference model to compare with the experimental results. For the completeness of the analysis, the FIM-FAM spectra of both resonances are measured in four different configurations. Labeling the two physical ends of the taper waist region as A and B (bottom inset of FIG. 14, Panel a), the FIM-FAM spectra shown previously in FIG. 13 in measured by launching the optical tones from B to A, and placing the drive 2 at a lower frequency compared to the drive 1 to drive the anti-Stokes sideband as the signal (FIG. 14, Panel b-III). Alternatively, the drive 2 can be put at a higher frequency compared to the drive 1 to drive the Stokes sideband (FIG. 14, Panel b-IV). These two spectra can also be measured in the opposite direction, from A to B instead (FIG. 14, Panel b-I for the anti-Stokes spectrum, FIG. 14, Panel b-II for the Stokes spectrum). In the total four different configurations, the original phonon self-interference model can be used to correctly anticipate the similarities of the FIM-FAM spectra measured in both opposite physical directions and different phase-matched sidebands, i.e. between FIG. 14, Panel b-I and FIG. 14, Panel b-IV, as well as between FIG. 14, Panel b-II and FIG. 14, Panel b-III. However, the dissimilarities between FIM-FAM spectra measured between either opposite physical directions or different phase-matched sidebands, i.e. between one of the FIG. 14, Panel b-I and IV, and one of the FIG. 14, Panel b-II and III, fail to be modelled with the original phonon self-interference theory.

FIM-FAM Measurements with Different Frequency Separations

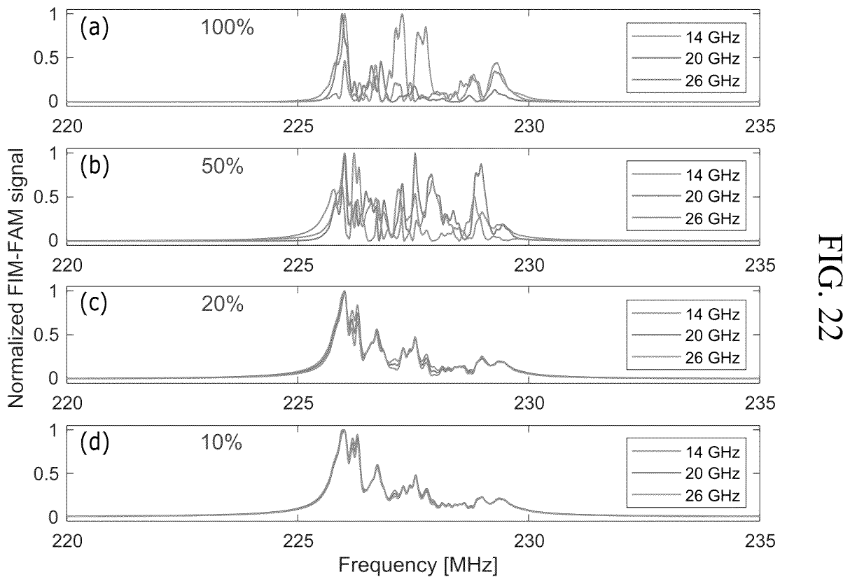

FIM-FAM spectra with different levels of accumulated phase mismatch due to the inter-modal dispersion are numerically calculated to be compared with the measurement results. depends on the frequency separation between the drives and the probe-signal pair. As the wavevector mismatch Δβ is proportional to the frequency separation Δω_{dp} shown in Eqn. (12), the accumulated phase mismatch is then also proportional to Δω_{dp} as has been indicated in FIG. 22. The study measured the changes in the experimental FIM-FAM spectra at different frequency separations Δω_{dp}/(2π) of 14 GHZ, 20 GHz and 26 GHz, with distinct FIM-FAM responses with differently measured 3-dB linewidth on the major FIM-FAM peaks. This indicates that the FIM-FAM response is influenced by Δω_{dp} as anticipated from the modified phonon self-interference model. The study also tried to numerical model these spectra variations with the modified model, with the group velocity difference term

$$( \frac{1}{{v}_{g - {TE}_{01} / {TM}_{01}}} - \frac{1}{{v}_{g - {HE}_{11}}} )$$

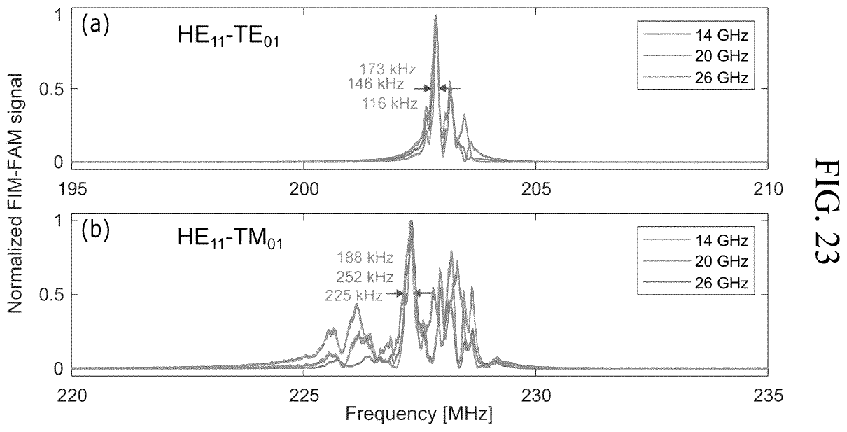

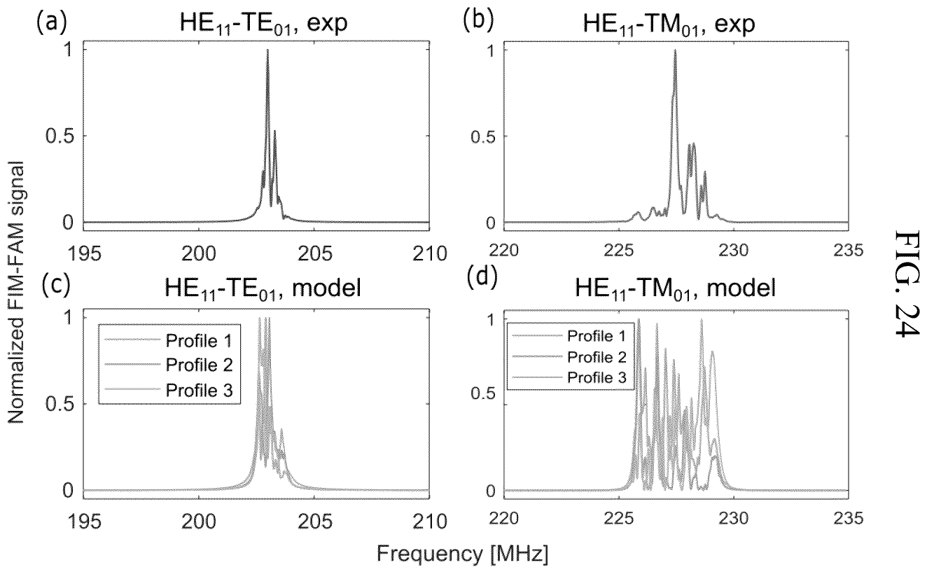

ranging from 100% to 10% of that calculated from the numerical simulations. As can be seen, larger introduced phase mismatch does lead to less similarity between the spectra with different frequency separations. This indicates that compared to the experimental results in FIG. 23, the practical mismatch should be milder compared to the numerically simulated results, possibly due to the non-considered material dispersion.

### The Modified Phonon Self-Interference Model

The spectral disagreements are eventually attributed to the intermodal dispersion of the two interacting optical modes. In the four-wave-mixing spectroscopy, at the FIM-FAM resonance, the frequency difference between the two drives corresponding to the FIM-FAM frequency at ˜200 MHz, which is also the same as the frequency difference between the probe and the FIM-FAM signal. These frequency separations are much smaller than the ˜20 GHz frequency separation between the drives-pair and the probe-signal pair, which is designed so that all the FBG filters have enough suppression of the unwanted optical tones. As a result, the dispersion of both optical modes leads to a slight difference between the phase-matched acoustic wavevector of the acoustic drives, and the phase-matched acoustic wavevector of the probe-signal pair. The previous phonon self-interference model is then modified by adding an extra phase-mismatch term within the signal generation process with the driven acoustic wave, similar to that in the theoretical model of the Kerr four-wave-mixing process. With theoretical derivations, the modified phonon self-interference model can accurately account for the similarities and dissimilarities previously shown in the measured FIM-FAM spectra with four configurations.

As has been shown in the FIM-FAM homogeneity sensitivity curves (FIG. 25), the FIM-FAM spectrum is largely influenced by the slight axial geometrical inhomogeneity of the fiber taper, due to the strong dependence of the FIM-FAM resonance on the local waist radius. In addition, the long decay length of the FIM-FAM phonon introduces non-negligible influence on the FIM-FAM response beyond the generation location along its propagation direction. For the configuration [AB]ₒ-[AB]ₐ, and [BA]ₒ-[BA]ₐ exciting the anti-Stokes sideband, according to the previous phonon self-interference model, the generation of the phase-matched anti-Stokes sideband is determined by the rate equations,

$${v}_{a} ( z ) \frac{db ( z )}{dz} = ( i ( Ω - {Ω}_{0} ( z ) ) - \frac{Γ ( z )}{2} ) b ( z ) - i {g}_{0}^{*} ( z ) {a}_{d 1} {a}_{d 2}^{*} \qquad ( 10 )$$

$${v}_{0} ( z ) \frac{{da}_{AS} ( z )}{dz} = - i {g}_{0} ( z ) b ( z ) {a}_{pr} \qquad ( 11 )$$

where vₒ, vₐ, Ω₀, Γ, g₀ refer to the optical group velocity of the HE₁₁ mode, acoustic group velocity of the fundamental flexural mode, FIM-FAM frequency, acoustic dissipation rate, and the optomechanical coupling rate, respectively. g₀ is related to the FIM-FAM gain coefficient (G_{OM}) by:

$${G}_{OM} = \frac{4 {\vert {g}_{0} \vert}^{2}}{ℏ ωΓ {v}_{o 1} {v}_{o 2}}$$

where vₒ₁ and vₒ₂ are the group velocities of the interacting optical modes. Among different subscripts, “d1” represents the drive 1, “d2” represents the drive 2, “pr” represents the probe light, and “AS” represents the anti-Stokes sideband carrying the FIM-FAM signal. The power of the optical fields (Pᵢ) is related to the amplitude (aᵢ) as Pᵢ=ℏωᵢv_{o,i}|aᵢ|², where the index i refers to different optical fields, h is the reduced Planck constant, and ω is the angular optical frequency. To properly model the experimental results, the original phonon self-interference model needs to be modified, starting with a re-examination of the four-wave mixing spectroscopy.

To avoid spurious RF signal generated at the photodetector from too many input optical tones at different frequencies, and also to prevent the detector from the power saturation, two acoustic drives are optically filtered out with several fiber Bragg gratings before the photodetector. The effectiveness of the fiber Bragg grating filters put a practical lower limit on the frequency separation between the drives pair and the probe/signal pair. Thus, there will be a mismatch between the driven acoustic wavevector (q) and the optical wavevector difference between the probe and the FIM-FAM signal. The mismatch accumulates along the whole taper waist and continuously influences to the FIM-FAM spectra. To include the slight wavevector mismatch here, an extra phase term is added on the FIM-FAM signal generation process as

$${v}_{0} ( z ) \frac{{da}_{AS} ( z )}{dz} = - i {g}_{0} ( z ) b ( z ) {a}_{p} ( z ) {e}^{i {\int }_{0}^{z} Δ {β}_{AS} ( u ) du} \qquad ( 12 )$$

Here, βᵢ (i=d1, d2, p, AS) corresponds to the propagation constants of the four optical tones, and

$$Δ {β}_{AS} = ( {β}_{AS} - {β}_{pr} ) - q = ( {β}_{AS} - {β}_{pr} ) - ( {β}_{d 1} - {β}_{d 2} ) \qquad ( 13 )$$

represents the wavevector mismatch. As the two acoustic drives are close in frequency with an average frequency ω_{d}, and the probe and FIM-FAM signal are also close in frequency with an average frequency ωₚ, the Eqn. (11) can be approximated as

$$\begin{matrix}Δ {β}_{AS} \approx ( {β}_{HE 11} - {β}_{TE 01 / TM 01} ) {\vert}_{ω = {ω}_{p}} - ( {β}_{HE 11} - {β}_{TE 01 / TM 01} ) {\vert}_{ω = {ω}_{d}} \\ = \frac{Δ {β}_{HE 11}}{Δ ω} ( {ω}_{p} - {ω}_{d} ) - \frac{Δ {β}_{TE 01 / TM 01}}{Δ ω} ( {ω}_{p} - {ω}_{d} ) \\ = ( \frac{Δ {β}_{TE 01 / TM 01}}{Δ ω} - \frac{Δ {β}_{HE 11}}{Δ ω} ) {Δω}_{dp} \\ \approx - ( \frac{1}{{v}_{g - TE 01 / TM 01}} - \frac{1}{{v}_{g - HE 11}} ) {Δω}_{dp}\end{matrix} \qquad ( 14 )$$

Here, the β's and the v_{g}'s are the wavevectors and the group velocities of the corresponding optical modes. Eqn. (12) indites that the wavevector mismatch is caused by the intermodal dispersion originating from the group velocity different between the HE11 and TE01/TM01 modes in the few-mode taper, which universally exist in multimode systems and will scale approximately linearly with the frequency separation Δω_{dp}=ω_{d}−ωₚ>0 when Δω_{dp} is small. Δβ_{AS} can be calculated numerically from finite element simulations as a function of Δω_{dp} between the acoustic drives and the probe-signal pair in the four-wave mixing spectroscopy. The rate equation of the phonon generation process remains the same as Eqn. (26).

The study explored the influence of the added phase term from examining the theoretical FIM-FAM spectra of the configurations [AB]ₒ-[AB]ₐ, and [BA]ₒ-[BA]ₐ, between which the original phonon self-interference model failed to anticipate the large distinctions. As the rate equation of the phonon generation process remains unmodified, the solutions of the phonon amplitude of the two configurations remains unchanged compared to the original model. For the configuration [AB]ₒ-[AB]ₐ, from the Eqn. (10),

$$\frac{{da}_{AS}^{{[ AB ]}_{o} - {[ AB ]}_{a}} ( z )}{dz} = - {a}_{d 1} {a}_{d 2}^{*} {a}_{p} \frac{{g}_{0} ( z )}{{v}_{o} ( z )} exp ( i {\int }_{0}^{z} Δ {β}_{AS} ( u ) du ) {\int }_{0}^{z} \frac{{g}_{0}^{*} ( ε )}{{v}_{a} ( ε )} exp ( {\int }_{ε}^{z} γ ( Ω , u ) du ) d ε \qquad ( 15 )$$

Then with an integration along the axial direction,

$${a}_{AS}^{{[ AB ]}_{o} - {[ AB ]}_{a}} = - {a}_{d 1} {a}_{d 2}^{*} {a}_{p} {\int }_{0}^{L} {\int }_{ε}^{L} \frac{{g}_{0} ( z )}{{v}_{o} ( z )} \frac{{g}_{0}^{*} ( ε )}{{v}_{a} ( ε )} exp ( i {\int }_{0}^{z} Δ {β}_{AS} ( u ) du ) exp ( {\int }_{ε}^{z} γ ( Ω , u ) du ) dz d ε \qquad ( 16 )$$

For the configuration [BA]ₒ-[BA]ₐ, similarly we can also derive the signal strength as

$${a}_{AS}^{{[ BA ]}_{o} - {[ BA ]}_{a}} = - {a}_{d 1} {a}_{d 2}^{*} {a}_{p} {\int }_{0}^{L} {\int }_{0}^{{z}^{′}} \frac{{g}_{0} ( L - {z}^{′} )}{{v}_{o} ( L - {z}^{′} )} \frac{{g}_{0}^{*} ( L - {ε}^{′} )}{{v}_{a} ( L - {ε}^{′} )} exp ( i {\int }_{0}^{{z}^{′}} Δ {β}_{AS} ( L - u ) du ) exp ( {\int }_{{ε}^{′}}^{{z}^{′}} γ ( Ω , L - u ) du ) d {ε}^{′} {dz}^{′} \qquad ( 17 )$$

With z=L−z′, ε=L−ε′ and u′=L−u, finally we have

$${a}_{AS}^{{[ BA ]}_{o} - {[ BA ]}_{a}} = - {a}_{d 1} {a}_{d 2}^{*} {a}_{p} {\int }_{L}^{0} {\int }_{L}^{z} \frac{{g}_{0} ( z )}{{v}_{o} ( z )} \frac{{g}_{0}^{*} ( ε )}{{v}_{a} ( ε )} exp ( - i {\int }_{L}^{z} Δ {β}_{AS} ( {u}^{′} ) {du}^{′} ) exp ( {\int }_{L - ε}^{L - z} γ ( Ω , L - u ) du ) d ε dz = - {a}_{d 1} {a}_{d 2}^{*} {a}_{p} {\int }_{0}^{L} {\int }_{z}^{L} \frac{{g}_{0} ( z )}{{v}_{o} ( z )} \frac{{g}_{0}^{*} ( ε )}{{v}_{a} ( ε )} exp ( i {\int }_{z}^{L} Δ {β}_{AS} ( {u}^{′} ) {du}^{′} ) exp ( - {\int }_{ε}^{z} γ ( Ω , {u}^{′} ) {du}^{′} ) d ε dz \qquad ( 18 )$$

Again, with a label switch between ε and z, Eqn. (16) can be adapted to

$${a}_{AS}^{{[ BA ]}_{o} - {[ BA ]}_{a}} = - {a}_{d 1} {a}_{d 2}^{*} {a}_{p} {\int }_{0}^{L} {\int }_{ε}^{L} \frac{{g}_{0} ( ε )}{{v}_{o} ( ε )} \frac{{g}_{0}^{*} ( z )}{{v}_{a} ( z )} exp ( i {\int }_{ε}^{L} Δ {β}_{AS} ( u ) du ) exp ( {\int }_{ε}^{z} γ ( Ω , {u}^{′} ) {du}^{′} ) dz d ε \qquad ( 19 )$$

Compared to the original model, except for the negligible differences from the variables vₒ, vₐ, g₀, an major difference is introduced into the modified PSI model between two phase terms: the

$$exp ( i {\int }_{0}^{z} Δ {β}_{AS} ( u ) du )$$

term in the configuration [AB]ₒ-[AB]ₐ, and the

$$exp ( i {\int }_{ε}^{L} Δ {β}_{AS} ( u ) du )$$

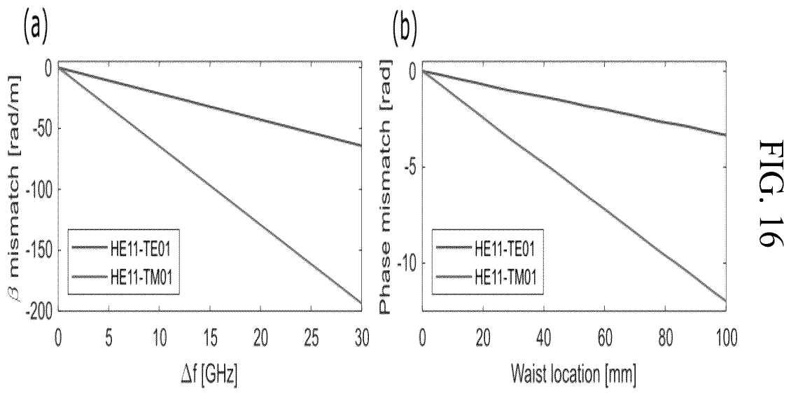

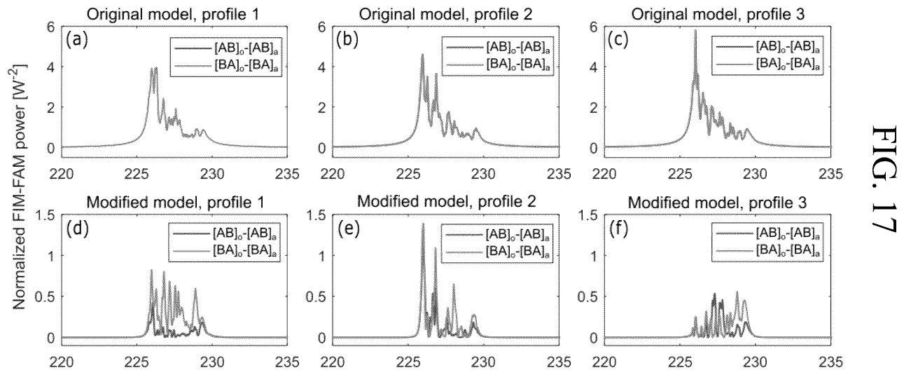

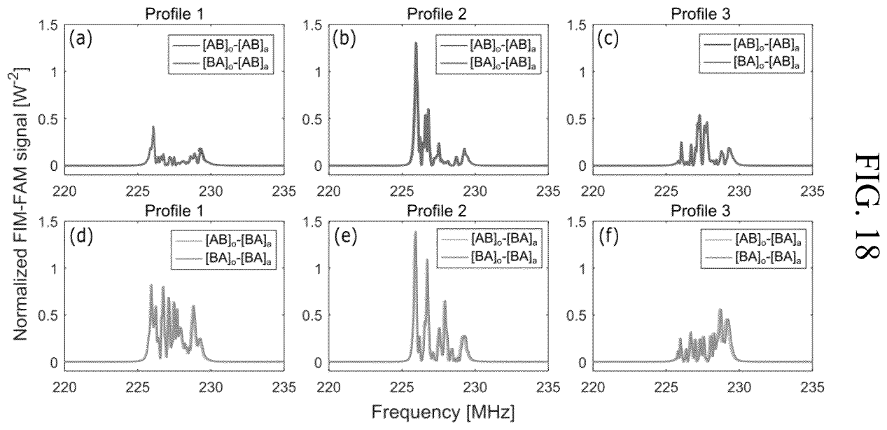

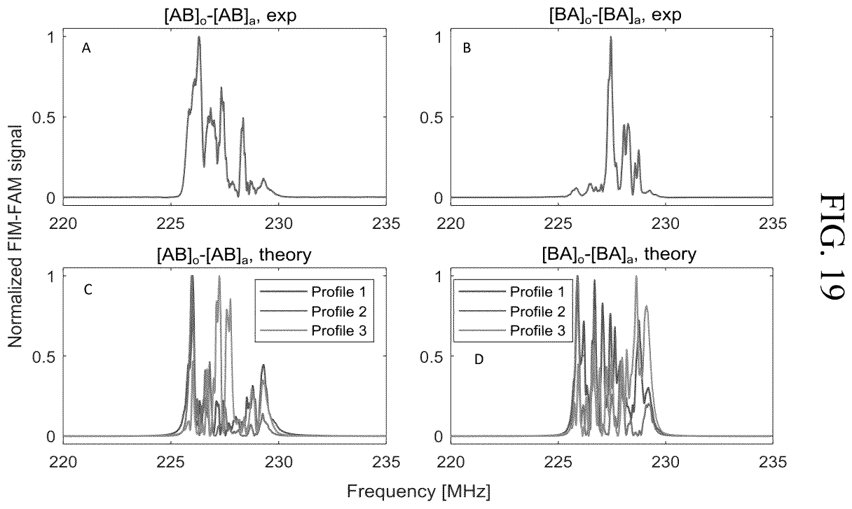

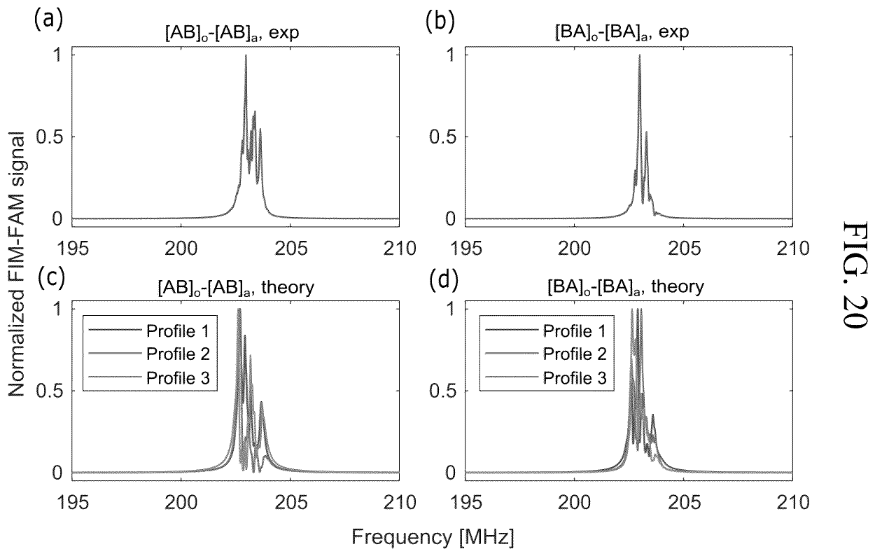

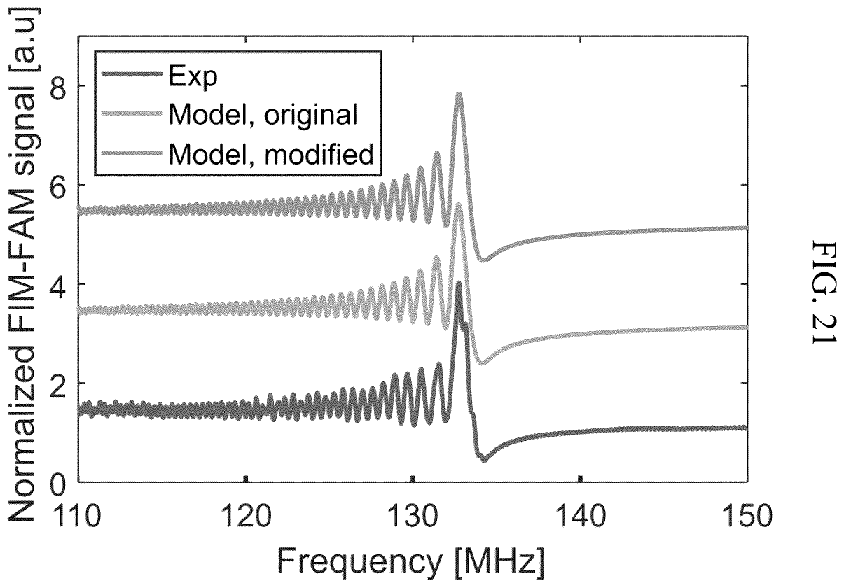

term in the configuration [BA]ₒ-[BA]ₐ within the double integrals. These two terms, which lead to the accumulated phase mismatch from two ends of the waist region to certain axial locations respectively, clearly differ as functions of ε and z, naturally creating different FIM-FAM spectra between the configurations [AB]ₒ-[AB]ₐ, and [BA]ₒ-[BA]ₐ. Numerical calculations from the rate equations verify the mathematical calculations FIG. 17). Note that in order to correctly further compare the modelled and measured FIM-FAM spectra, the FIM-FAM signal strength here as well as in several following figures is represented by the normalized FIM-FAM power, calculated from the FIM-FAM signal power from the waist region normalized by the optical power of the two acoustic drives and the probe, with a final unit of W⁻². The difference between the FIM-FAM spectra of the configurations [AB]ₒ-[BA]ₐ and [BA]ₒ-[AB]ₐ can be explained in a similar way.

Further analysis focuses on the similarity between the configuration [AB]ₒ-[AB]ₐ and [BA]ₒ-[AB]ₐ, as well as between [AB]ₒ-[AB]ₐ a and [BA]ₒ-[BA]ₐ. For the configurations [AB]ₒ-[BA]ₐ and [BA]ₒ-[AB]ₐ, the signal in the Stokes sideband is generated instead. Now the FIM-FAM rate equations are similar to the Eqn. (26) and (10)

$${v}_{a} ( z ) \frac{db ( z )}{dz} = {v}_{a} ( z ) γ ( Ω , z ) b ( z ) - i {g}_{0}^{*} ( z ) {a}_{d 1}^{*} {a}_{d 2} \qquad ( 20 )$$

$${v}_{0} ( z ) \frac{{da}_{S} ( z )}{dz} = - i {g}_{0}^{*} ( z ) {b}^{*} ( z ) {a}_{p} {e}^{i {\int }_{o}^{z} Δ {β}_{S} ( u ) du} \qquad ( 21 )$$

Here, Δβ_{S}=(β_{S}−βₚ)−q=(β_{S}−βₚ)−(β_{d1}−β_{d2}). Note that the rate equation for the phonon driving process also changes slightly due to the relative frequency between the two acoustic drives. For the configuration [AB]ₒ-[AB]ₐ, the phonon amplitude is derived from Eqn. (18) as

$${b}^{{[ AB ]}_{o} - {[ BA ]}_{a}} ( z ) = - {ia}_{d 1}^{*} {a}_{d 2} {\int }_{0}^{z} \frac{{g}_{0}^{*} ( ε )}{{v}_{a} ( ε )} exp ( {\int }_{ε}^{z} γ ( Ω , u ) du ) d ε \qquad ( 22 )$$

And the FIM-FAM signal amplitude at the output is

$${a}_{S}^{{[ AB ]}_{o} - {[ BA ]}_{a}} = {a}_{S}^{{[ AB ]}_{o} - {[ BA ]}_{a}} ( L ) = {a}_{d 1} {a}_{d 2}^{*} {a}_{p} {\int }_{0}^{L} {\int }_{ε}^{L} \frac{{g}_{0}^{*} ( z )}{{v}_{o} ( z )} \frac{{g}_{0} ( ε )}{{v}_{a} ( ε )} exp ( i {\int }_{0}^{z} Δ {β}_{S} ( u ) du ) exp ( {\int }_{ε}^{z} {γ}^{*} ( Ω , u ) du ) dz d ε \qquad ( 23 )$$

The complex conjugate of the Stokes amplitude, after some calculations, can be rewritten as

$${a}_{s}^{* {[ AB ]}_{o} - {[ BA ]}_{a}} = {a}_{d 1}^{*} {a}_{d 2} {a}_{p}^{*} Φ ( L ) {\int }_{0}^{L} {\int }_{ε}^{L} \frac{{g}_{0} ( z )}{{v}_{o} ( z )} \frac{{g}_{0}^{*} ( ε )}{{v}_{a} ( ε )} exp ( i {\int }_{ε}^{L} Δ {β}_{S} ( u ) du ) exp ( {\int }_{ε}^{z} {γ}_{O} ( Ω , u ) du ) dz d ε \qquad ( 24 )$$

Here

$$Φ ( L ) = exp ( - i {\int }_{0}^{L} Δ {β}_{S} ( u ) du ) , and \qquad ( 25 )$$

$${γ}_{O} ( Ω , z ) = γ ( Ω , z ) - i Δ {β}_{S} ( z ) = \frac{1}{{v}_{a} ( z )} ( i ( Ω - ( {Ω}_{0} ( z ) + {v}_{a} ( z ) Δ {β}_{S} ( z ) ) ) - \frac{Γ ( z )}{2} )$$

Since the FIM-FAM frequency is only ˜200 MHz, which is only ˜1% of the frequency separation between the drives pair and the probe/signal pair (20 GHz), the dispersion relations among the four optical tones remains unchanged between the configuration [AB]ₒ-[AB]ₐ/[BA]ₒ-[BA]ₐ and [AB]ₒ-[BA]]ₐ/[BA]ₒ-[AB]ₐ, meaning that Δβ_{AS}(z)≈Δβ_{S}(z). Comparing the Spectra from configurations [AB]ₒ-[BA]ₐ and [BA]ₒ-[BA]ₐ, which separately corresponds to Eqns. (17) and (22), despite for the minor changes on the vₒ, vₐ, g₀ we've been discussing about,

$${a}_{AS}^{{[ BA ]}_{o} - {[ BA ]}_{a}} ( Ω ) \approx {a}_{S}^{* {[ AB ]}_{o} - {[ BA ]}_{a}} ( Ω + {v}_{a} ( z ) Δ {β}_{S} ( z ) ) exp ( i {\int }_{0}^{L} Δ {β}_{S} ( u ) du ) .$$

In term of the signal optical power proportional to |a_{S}|² and |a_{AS}|², the extra accumulated phase term brings no influence, and it ends up with

$${\vert {a}_{AS}^{( 3 )} ( Ω ) \vert}^{2} \approx {\vert {a}_{S}^{{[ AB ]}_{o} - {[ BA ]}_{a}} ( Ω + {v}_{a} ( z ) Δ {β}_{S} ( z ) ) \vert}^{2} ,$$

indicating that the configurations [AB]ₒ-[BA]ₐ and [BA]ₒ-[BA]ₐ should share similar spectra other than an frequency offset determined by vₐ(z)Δβ_{S}(z) that roughly starts as a constant within the waist region. Based on the numerical simulations, the acoustic velocity vₐ lies around 2600 m/s in the waist region, and the ABs lies around −130 rad/m (−40 rad/m) for the HE11-TM01 (HE11-TE01) interaction. Their product vₐ(z)Δβ_{S}(z) is then much smaller compared to Ω, only leading to a small theoretical frequency offset of ˜50 kHz (˜15 kHz) on top of the ˜200 MHz FIM-FAM frequency. Since the practical ABs should be smaller than the simulation results (discussed later), the tiny frequency offset will be indistinguishable in the experimental FIM-FAM spectra, leading to similar responses for configurations [AB]ₒ-[BA]ₐ and [BA]ₒ-[BA]ₐ, which can also be numerically verified. The similarity between the configurations [AB]ₒ-[AB]ₐ, and [BA]ₒ-[AB]ₐ can also be explained accordingly.

With the modified phonon self-interference model and the three algorithm-generated hypothetical waist profile, the study recalculates the theoretical FIM-FAM responses for both HE11-TM01 and HE11-TE01 resonances. All the modelled FIM-FAM responses quantitatively match the multi-peak nature of the experimental results, where the differences are caused by the ambiguity of the actual waist profile due to an absence of an accurate and non-destructive profile measurement method.

While it has been used to successfully explain the taper-based FIM-FAM spectra, it fails to explain the spectral disagreements between different configurations when the same FIM-FAM sideband is measured in opposite physical directions, i.e. between configurations [AB]ₒ-[AB]ₐ, and [BA]ₒ-[BA]ₐ, and between configurations [AB]ₒ-[BA]ₐ and [BA]ₒ-[AB]ₐ. For example, based on the equations Eqn. (12) and (13), following similar derivation traces as the modified model discussed above, the signal amplitudes at the taper output of the [AB]ₒ-[AB]ₐ and [BA]ₒ-[BA] a configurations,

$${a}_{AS}^{{[ AB ]}_{o} - {[ AB ]}_{a}} = - {a}_{d 1} {a}_{d 2}^{*} {a}_{p} {\int }_{0}^{L} {\int }_{ε}^{L} \frac{{g}_{0} ( z )}{{v}_{o} ( z )} \frac{{g}_{0}^{*} ( ε )}{{v}_{a} ( ε )} exp ( {\int }_{ε}^{z} γ ( Ω , u ) du ) dz d ε \qquad ( 26 )$$

$${a}_{AS}^{{[ BA ]}_{o} - {[ BA ]}_{a}} = - {a}_{d 1} {a}_{d 2}^{*} {a}_{p} {\int }_{0}^{L} {\int }_{ε}^{L} \frac{{g}_{0} ( ε )}{{v}_{o} ( ε )} \frac{{g}_{0}^{*} ( z )}{{v}_{a} ( z )} exp ( {\int }_{ε}^{z} γ ( Ω , {u}^{′} ) {du}^{′} ) dz d ε \qquad ( 27 )$$

Neglecting the slight variation of the variables including g₀, vₒ, vₐ within the taper waist, these two configurations will have almost identical FIM-FAM responses, which clearly doesn't match the measurements herein. This is also illustrated with theoretical spectra modelled with the hypothetical waist profiles.

In addition, the results of the FIM-FAM demonstrated in the previous inhomogeneous few-mode taper are re-examined with the modified phonon self-interference model, in order to double check the previous claim on the validity of the original model. On the previous inhomogeneous few-mode taper, the waist region is approximately parabolic instead of being flat, and the waist length is only as short as 10 mm, on the same level as the phonon decay length. As a result, the accumulated phase mismatch is much smaller than that in a long and homogeneous taper shown in this paper, that the extra phase mismatch term only brings negligible change across the whole FIM-FAM spectrum.

In typical Brillouin-based applications, where only the strong FIM-FAM pump and the weak FIM-FAM probe are present without additional acoustic drives, the system remains unaffected by intermodal dispersion. Consequently, the FIM-FAM responses remain identical irrespective of the chosen Brillouin sidebands or the device orientation.

The modelled FIM-FAM spectra calculated with the hypothetical waist profiles can also be used to qualitatively examine the validity of the numerically simulated FIM-FAM gain coefficient G_{OM}. According to the gain coefficient formula, G_{OM} is proportional to the square of the vectorial overlap between the optical forces and the acoustic displacement field over the cross-section of the taper waist, and inversely proportional to the square of the FIM-FAM frequency. The disagreements between the simulated FIM-FAM frequencies (189 MHz for TE01 and 210 MHz for TM01) and the experimental central resonances (203 MHz for TE01 and 227 MHz for TM01) indicate the practical deviation of the actual FIM-FAM response from the numerical results, originating from the uncertainties on the optical and acoustic properties of the fiber taper material, and the non-zero axial strain of the fiber taper. To partially compensate for this, the simulated G_{OM} values are corrected by substituting the measured FIM-FAM resonant frequencies from the measurements into the gain coefficient formulas, with new G_{OM} at 439 W⁻¹m⁻¹ for the TE₀₁ resonance and 306 W⁻¹m⁻¹ for the TM₀₁ resonance. On the other hand, while the effective G_{OM}×L of the major FIM-FAM peaks have been calculated for TE01 and TM01 resonances, the FIM-FAM signal power in the remaining part of the FIM-FAM spectra are not considered. To characterize the G_{OM}, the FIM-FAM signal power over the entire spectra is calculated as

$${P}_{sig - tot} = {\int }_{0}^{∞} {P}_{sig} ( Ω ) d Ω ,$$

where P_{sig}(Ω) is the measured power spectral density of the FIM-FAM spectra. For the experimental results, P_{sig-tot} can be directly calculated as

$${P}_{sig - tot}^{exp} ,$$

with the configuration coupling light from the physical end A to end B to measure the phase-matched anti-Stokes sideband. With the same configuration, the three hypothetical curves and an arbitrary gain coefficient G₀ are put into the modified phonon self-interference model to calculate the P_{sig-tot} for the modelled spectra

$$( {P}_{sig - tot}^{model} ) .$$

As P_{sig}(Ω) is proportional to

$${G}_{OM}^{2}$$

in the four-wave mixing spectroscopy, the experimental gain coefficients Gₑₛₜ can be estimated as

$${G}_{0} \sqrt{{P}_{sig - tot}^{exp} / {P}_{sig}^{model}}$$

for all three profiles, corresponding to the situations when

$${P}_{sig - tot}^{exp} = {P}_{sig - tot}^{model} ,$$

with Gₑₛₜ in the modified model instead. With the profiles 1, 2 and 3, the calculations yield experimental optomechanical gain coefficients of 320 W⁻¹m⁻¹, 230 W⁻¹m⁻¹ and 220 W⁻¹m⁻¹ for the TE₀₁ resonance and 280 W⁻¹m⁻¹, 320 W⁻¹m⁻¹ and 380 W⁻¹m⁻¹ for the TM₀₁ resonance, in qualitative agreements with the simulated gain values.

### Minimizing Homogeneity Sensitivity

The phase-matched FIM-FAM frequency has a strong dependence on the local taper waist radius. Because the difference in effective optical indices of the fundamental and higher-order optical modes as well as the phase velocity of the fundamental acoustic wave depend on the waist radius, the FIM-FAM frequency is a complex function of the axial waist variation. Using a refractive index of 1.444 for the fused silica and the optical wavelength at 1550 nm, the effective indices of the guided optical modes can be numerically simulated with finite element solvers for any waist radius, and the phase-matched acoustic wavevector is then used with the density (2203 kg/m³), the pressure-wave speed (5903 m/s) and the shear-wave speed (3709 m/s) to calculate the FIM-FAM frequency. The FIM-FAM frequency is then calculated vs. waist radius for the possible interactions between the HE₁₁ mode and three different higher-order modes, TE₀₁, TM₀₁ and HE₂₁. Each interaction has a peak frequency in which the frequency is locally independent of the radius, which for interactions the TE₀₁, TM₀₁ and HE₂₁ modes are calculated as 609 nm (r₁), 707 nm (r₂) and 679 nm (r₃) respectively. These values are expected to vary slightly because of the <10% variation for the measured frequency vs prediction. The dependence in FIG. 25 is corrected by a corresponding vertical shift such that it aligns with the measured frequencies at 615 nm radius, but a complete model would require the complete mechanical properties of the material and the axial strain profile of the taper. Importantly, the axial inhomogeneity of the radius will broaden the FIM-FAM spectral response in proportion to the slope of this frequency dependence on radius. Since the frequency variation for interactions with the TE₀₁ resonance is predicted to be less than that from the TM₀₁ resonance (comparing the slopes in FIG. 25) the corresponding linewidth from the TE₀₁ resonance should be narrower, which is consistent with the experimental results in FIG. 13, Panel c.

Quantifying Taper Homogeneity from the FIM-FAM Frequency Response

The FIM-FAM frequency dependence on the variation of the taper geometry for different samples can be quantified from the measured frequency responses using effective linewidths. Given the large qualitative variations of spectral features between different resonances and tapers an averaged or effective linewidth approach is adopted, as commonly used for narrow-linewidth fiber lasers and amplifiers [44]. We therefore apply a root-mean-square (RMS) linewidth [47,48], which integrates the system response across the active frequency range. Using a similar moment-based method the central frequency is given is given by the first moment of the spectra (centroid) as

$${Ω}_{c} = \frac{\int {P}_{s} ( Ω ) Ω d Ω}{\int {P}_{s} ( Ω ) d Ω} , \qquad ( 28 )$$

where Ω is the FIM-FAM frequency, Pₛ(Ω) is the FIM-FAM signal power spectrum, and the integration is the region where the signal is above the noise around the resonance. The RMS linewidth is then calculated as the second moment of the spectra, with the equation

$$Δ {Ω}_{RMS} = 2 \sqrt{\frac{\int {P}_{s} ( Ω ) {( Ω - {Ω}_{c} )}^{2} d Ω}{\int {P}_{s} ( Ω ) d Ω}} . \qquad ( 29 )$$

In the taper sample analyzed in the main text, the RMS linewidth of the interaction with the TE01 mode is 756 kHz, and the RMS linewidth for the TM₀₁ mode is larger at 1.44 MHz. In contrast, on the other taper sample demonstrated with a slightly larger taper waist size, the RMS linewidth for the TE01 and TM₀₁ interactions are similar at 1.52 MHz and 1.50 MHz, respectively. The difference of the ratios between the RMS linewidths of the two resonances at different waist radii is consistent with predictions that near 650 nm radius the slopes of the two frequency dependent curves are closer than at 615 nm. Future taper samples can be fabricated specifically with the aim of targeting the radius at which the frequency varies minimally with radius to minimize the overall response linewidth for narrow-linewidth demanding photonic applications.

Therefore, to further improve the linewidth toward intrinsic dissipation levels, the fabrication is designed with the same fixed inhomogeneity to finely sample the mean radius with the aim of reaching the radius where the frequency varies the least. In addition, environmental (e.g. temperature) controls are introduced around the taper to compensate for any post-fabrication drifts from this peak value.

### Example 3: Alternative Taper Design with Reduced Waist Length but Lower Optical Loss

The total FIM-FAM gain G of this taper sample, while unexpectedly advantageous, can still be enhanced with further optimized design and fabrication. According to the FIM-FAM measurements, the maximum effective total gain G_eff appears on the HE11-TE01 resonance at around 0.115, where an input pump power of 100 mW at the mode selective coupler is assumed. The total gain can also be improved with better geometrical and dispersion-dependent homogeneities, so that a longer section of the waist region contributes to the major peak in the final FIM-FAM response. In addition, the improvement on the optical transmission of the higher-order optical modes at the input transition region can also increase the available pump power at the waist region. The adiabaticity of the fiber taper describing the degree of dissipation of the optical modes in the transition regions can also be investigated. To increase to transmission of the high-order modes, another taper sample sharing a similar homogeneous waist profile is designed and fabricated with smaller local angles in the transition regions, at the cost of elongated transition regions and a shorter waist length at 35 mm.

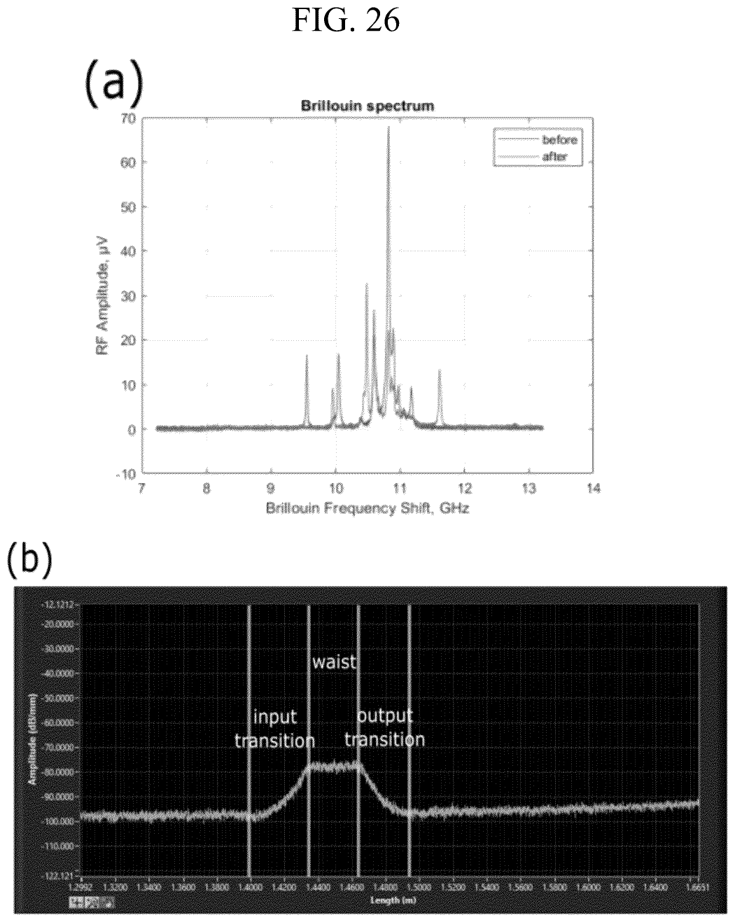

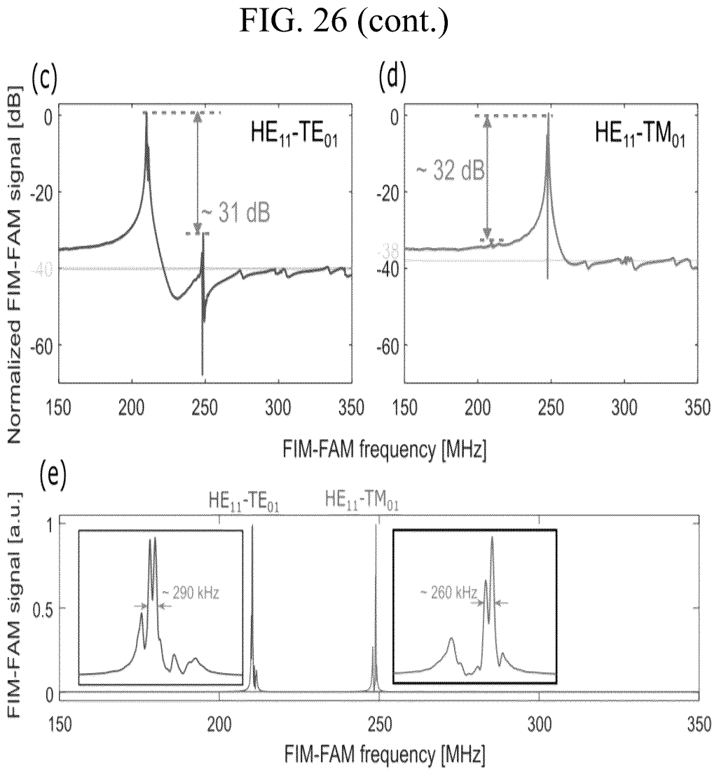

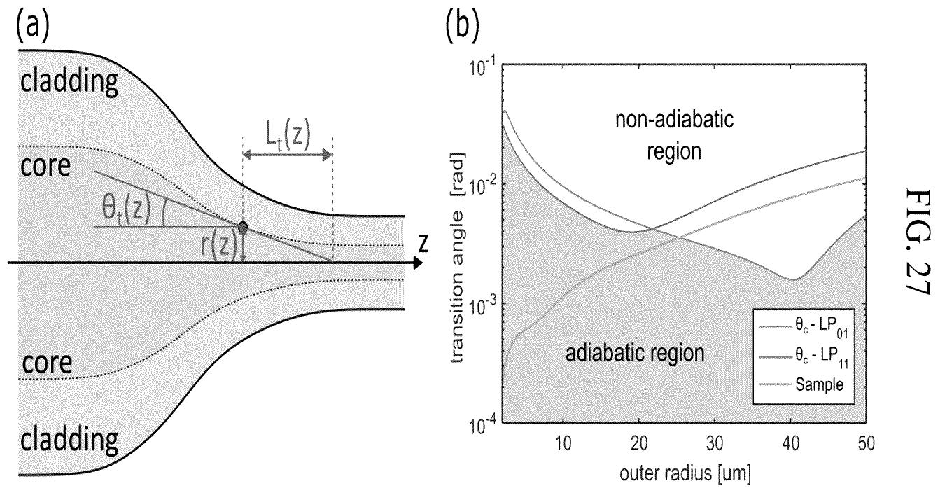

For the same fabrication set-up it is possible to make a fiber taper with a reduced waist length but longer transition regions, with the overall taper length fixed by the translation stages. While the reduced waist length reduces the coupling region, the longer transition regions should enable lower optical losses for the light coupling into the waist. To investigate this design variation, another taper sample is fabricated with a longer transition region and a shorter 35-mm waist region (a-b). In principle, smaller transition angles should lead to smaller optical losses for both the LP₀₁ and LP₁₁ modes. Measurements of the fabricated device's transmission after packaging and shipping show transmission of the HE₁₁ mode of ˜83%, and transmissions of TM₀₁ and TM₀₁ modes of >17% and 16%, respectively, which is a factor of 4 times more transmission that in the other measured taper design. Forward intramodal scattering described herein is used to determine the waist radius, which is found to vary from 642 nm to 655 nm, which is around 2% total variation, as with the previous sample. The FIM-FAM response is measured for interactions with the TE₀₁ and TM₀₁ modes, showing similar spectra to the previous sample with resonances at 210 MHz and 249 MHz due to the new waist radius (FIG. 26, Panel c-e). Also, the contrast between the background resonances remains over 30 dB with suitable control of the input polarization state. The 3-dB linewidths of the dominant resonances are slightly larger at around 270 kHz. Measurements of this alternative sample demonstrates the potential for further increasing the transmission for the higher-order optical modes as analyzed further herein.

### Taper Adiabaticity

While achieving better high-order mode transmissions over 15%, further transmission improvements are limited by the length requirement of the waist region for efficient FIM-FAM. The tradeoff between the transition angle and the waist length is limited by the current profile design of the transition regions, and can be surpassed with further improvements on the transition region design and the fabrication algorithms.

The transmission of the optical modes through the fiber taper is determined by how adiabatic the transitions are from the two-mode fiber to the waist region. Here we analyze the conditions for which the taper is sufficiently adiabatic to avoid transition losses for each participating optical mode, where one supports the pump and the other, the signal. The optical adiabaticity is determined by the local tapering angle as a function of its axial location. In fiber tapers with a circular transverse cross-section, the degenerate LPₗₘ modes will only couple to other higher-order modes with the same azimuthal number l and a different radial number n. The beat length between the original and cross-coupled LP modes is L_{b}=2π/(Bₘ−Bₙ), where βₘ is the wavevector of the original LPₗₘ optical mode, and βₙ is the propagation constant of the undesired cross-coupled LPₗₙ mode (n>m). On the other hand, the local slope of the taper can be described by the length-scale, Lₜ=r/θₜ, where r is the local radius of the taper and θₜ is the local taper angle (a). To achieve minimal cross-coupling to the unguided optical modes in the taper, θₜ should be minimized everywhere, which means a large Lₜ is preferred for an adiabatic transmission. Following a previous analysis with a corresponding successful experimental demonstration, the optical modes propagating in the fiber taper are sufficiently adiabatic as long as Lₜ»L_{b}. This is further guaranteed when Lₜ»L_{b,max}, where L_{b,max} corresponds to the maximum beat length with minimum difference between βₘ and βₙ, when n=m+1.

To assist with taper design, the study defines a critical taper angle, θ_{c}, as θ_{c}=(βₘ−βₙ)r/(2π), with which Lₜ=L_{b}. The local angle should be much smaller than this critical angle everywhere in an adiabatic taper. For the fundamental LP₀₁ mode corresponding to l=0 and m=1, the critical angle is numerically calculated when n=2, between the LP₀₁ and LP₀₂ modes across the whole taper radius range. Similarly, the critical angle for the LP₁₁ mode (l=m=1) is calculated between the LP₁₁ and LP₁₂ (n=2) modes. These critical angles are plotted along with the values from the designed transition profile of the taper sample analyzed in the main text, as a function of the local taper radius (FIG. 26, Panel b). While the real taper angle is smaller than the adiabaticity critical angle of the LP₀₁ mode across the whole transition region, it is not always satisfying this condition for the LP₁₁ mode, particularly in the large radius region where the actual angle can be much larger than the critical angle. These results are consistent with the measured low transmission for the LP₁₁ mode and the much higher transmission for the LP₀₁ mode. In order to greatly improve the adiabaticity of the LP₁₁ mode to achieve a higher pump power in the taper waist, the local taper angle in the large outer radius regime should be further decreased in the future samples with optimized profiles of the transmission regions (e.g., see the low-loss taper sample demonstrated in a narrow bandwidth microwave photonic filter).

### Further Embodiments

The resonance frequency can be further reduced from the 200 MHz level in this work with smaller acoustic wavevectors by narrowing the difference on effective refractive indices between two interacting modes, by utilizing different optical mode families, or increasing the taper radius at the cost of a greater number of guided optical modes and weaker FIM-FAM interaction strength. The acoustic loss can also be improved by reducing the ambient temperature of the waveguide [ ] and refining the fabrication process to reduce the surface scattering loss of the traveling acoustic wave. On the other hand, to avoid spectral broadening, variations of the central FIM-FAM resonances should be minimized with improved geometrical and dispersion-dependent homogeneities with designed average waist radius targeting the dispersion-less radii of the individual FIM-FAM resonances.

Taper samples with improved transition regions showing >50% transmission for the higher-order optical modes have been fabricated and used in the demonstration of sub-MHz linewidth microwave photonic bandpass filters taking the advantage of the narrow FIM-FAM linewidth in the few-mode fiber taper platform. In a 100% homogeneous and fully adiabatic (unity optical transmission) few-mode taper with the same 100 mm waist length, a total FIM-FAM gain as high as 4.39 is expected, with a near 40 times enhancement compared to the current FIM-FAM implementation. In the few-mode taper, it is challenging to further reduce the number of guided optical modes while still maintaining the multi-mode guidance of the waveguide, since the two higher-order TE01 and TM01 modes share the same cutoff radius. While the unwanted optical mode has been largely suppressed with comprehensive input polarization controls, the unwanted cross-coupling will always exist practically. This, combined with the additional challenge for further FIM-FAM frequency reductions with smaller mode indices difference, indicates that the design flexibility of the few-mode fiber taper platform for FIM-FAM is eventually limited by the transverse waveguide structure defined by the optical fiber before the fabrication. Other photonic platforms with a larger design space of the transverse waveguide structure might be alternative candidates for low-frequency and single-resonance FIM-FAM devices if the fundamental acoustic waves can still be well-confined with the large optomechanical gain.

FIM-FAM Measurements with Four Different Optical and Acoustic Configurations

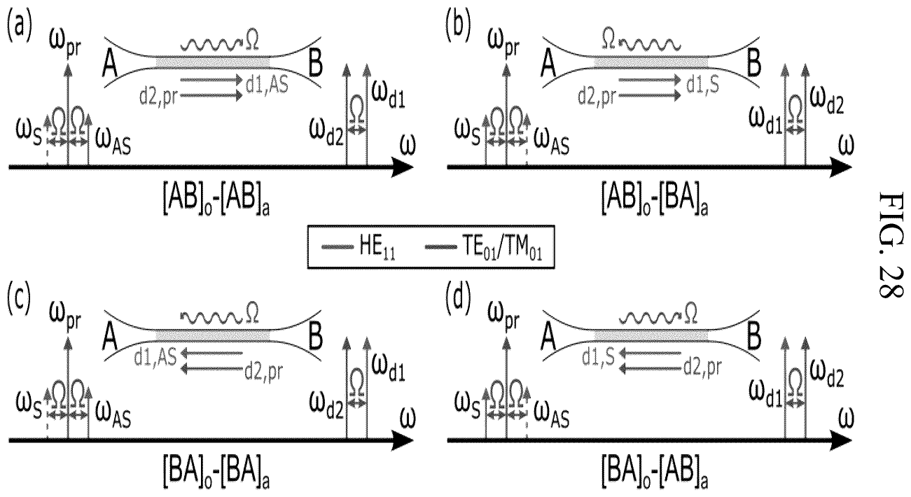

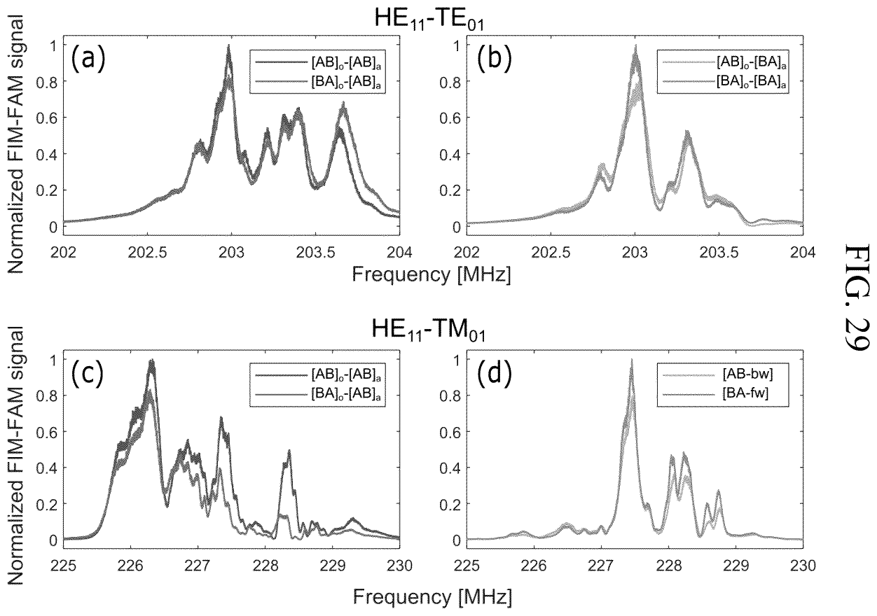

For a complete set of FIM-FAM characterizations on the few-mode fiber taper, the FIM-FAM spectra of the phase-matched sidebands are measured under different circumstances. (FIG. 28) Depending on the relative frequency relation between the two acoustic drives, either the Stokes or the anti-Stokes sideband is phase-matched to the driven acoustic wave to be excited. In order to explore the dynamics of the phonon self-interference in the fiber taper, the FIM-FAM responses are also measured from different input ends of the taper embodiment. To explicitly represent different measurement scenarios, two physical ends of the fiber taper are labelled as A and B. There are four different measurement configurations in total, which are labeled in the form of [XY]ₒ-[X′Y′]ₐ. In this notation, the first bracket with subscript ‘o’ represents the propagation direction of the optical tones, where X and Y represents the input and output ends of the optical tones respectively. The second bracket with subscript ‘a’ represents the propagation direction of the mediated acoustic wave propagating from end X′ to end Y′. For example, the FIM-FAM measurement from the configuration [BA]ₒ-[BA]ₐ has been what is demonstrated in the main text, where the fiber taper is measured by launching light from end B to end A, and the phase-matched anti-Stokes sideband is measured with traveling phonons with the same direction from B to A as the light. After experimentally characterizing FIM-FAM spectra for both HE11-TE01 and HE11-TM01 resonances, the spectra from the configurations [AB]ₒ-[AB]ₐ and [BA]ₒ-[AB]ₐ share a similarity, while the spectra from the configurations [AB]ₒ-[BA]ₐ and [BA]ₒ-[BA]ₐ share a different similarity. The distinctions and similarities of FIM-FAM spectra from different configurations are worth investigating further to better understand the phonon self-interference effect in the FIM-FAM.

The geometrical inhomogeneity of any traveling-wave optomechanical waveguide often introduces modifications on the otherwise single-peak optomechanical spectrum with a well-defined resonant frequency. As has been shown in the FIM-FAM dispersion curves, the FIM-FAM spectrum will be largely influenced by the axial geometrical inhomogeneity of the fiber taper, due to its strong dependence on the local waist radius. In addition, the long decay length of the FIM-FAM phonon introduces non-negligible influence on the FIM-FAM response at other regions other than its generation location along its propagation direction. For the configuration [AB]ₒ-[AB]ₐ, and [BA]ₒ-[BA]ₐ exiting the anti-Stokes sideband, according to the previous phonon self-interference model, the generation of the phase-matched anti-Stokes sideband is determined by the rate equations,

$${v}_{a} ( z ) \frac{db ( z )}{dz} = ( i ( Ω - {Ω}_{0} ( z ) ) - \frac{Γ ( z )}{2} ) b ( z ) - {ig}_{0}^{*} ( z ) {a}_{d 1} {a}_{d 2}^{*} \qquad ( 30 )$$

$${v}_{0} ( z ) \frac{{da}_{AS} ( z )}{dz} = - {ig}_{0} ( z ) b ( z ) {a}_{p} \qquad ( 31 )$$

where vₒ, vₐ, Ω₀, Γ, g₀ refer to the optical group velocity of the HE11 mode, acoustic group velocity of the fundamental flexural mode, FIM-FAM frequency, acoustic dissipation rate, and the optomechanical coupling rate, respectively. g₀ is related to the FIM-FAM gain coefficient (G_{OM}) by]:

$${G}_{OM} = \frac{4 {\vert {g}_{0} \vert}^{2}}{ℏ ω Γ {v}_{o} {v}_{o 2}}$$

where vₒ₂ is the group velocity of the interacting high-order mode. Among different subscripts, “d1” represents the drive 1, “d2” represents the drive 2, “p” represents the probe light, and “AS” represents the anti-Stokes sideband carrying the FIM-FAM signal. The power of the optical fields (Pᵢ) is related to the amplitude (aᵢ) as Pᵢ=ℏωᵢv_{o,i}|aᵢ|², where the index i refers to different optical fields, h is the reduced Planck constant, and ω is the angular optical frequency. While it has been used to successfully explain the taper-based FIM-FAM spectra in the previous demonstration, it fails to explain the spectral disagreements between different phase-matched sideband measured with the same light propagation direction, i.e. between configurations [AB]ₒ-[AB]ₐ and [AB]ₒ-[AB]ₐ, and between configurations [BA]ₒ-[BA]ₐ and [BA]ₒ-[AB]ₐ, which weakens the validity of the original phonon self-interference model.

While various embodiments have been described above, it should be understood that such disclosures have been presented by way of example only and are not limiting. Thus, the breadth and scope of the subject compositions and methods should not be limited by any of the above-described exemplary embodiments but should be defined only in accordance with the following claims and their equivalents.

The above description is for the purpose of teaching the person of ordinary skill in the art how to practice the present invention, and it is not intended to detail all those obvious modifications and variations of it which will become apparent to the skilled worker upon reading the description. It is intended, however, that all such obvious modifications and variations be included within the scope of the present invention, which is defined by the following claims. The claims are intended to cover the components and steps in any sequence which is effective to meet the objectives there intended, unless the context specifically indicates the contrary.

1. A multi-mode optical fiber taper for forward inter-modal Brillouin scattering with fundamental acoustic modes (FIM-FAM), comprising:
a first multi-mode fiber section having a first radius;
a second multi-mode fiber section having a second radius;
an axially homogeneous waist section having a third radius, wherein the third radius is smaller than the first radius and the second radius;
a first tapered transition section adiabatically connecting the first multi-mode fiber section to the waist section; and
a second tapered transition section adiabatically connecting the waist section to the second multi-mode fiber section.

2. The multi-mode optical fiber taper of claim 1, wherein the first multi-mode optical fiber is a two-mode optical fiber.

3. The multi-mode optical fiber taper of claim 2, wherein the third radius is in a range of 570 nm-900 nm.

4. The multi-mode optical fiber taper of claim 1, wherein the first multi-mode optical fiber is able to carry more than two optical modes.

5. The multi-mode optical fiber taper of claim 3, wherein the first multi-mode optical fiber is a three-mode optical fiber.

6. The multi-mode optical fiber taper of claim 5, wherein the third radius is in a range greater than 900 nm.

7. The multi-mode optical fiber taper of claim 1, wherein the axially homogeneous waist section has a uniform radius across the waist section with a precision of no more or no less than 10 nm.

8. The multi-mode optical fiber taper of claim 1, further comprising:
an air-material boundary or vacuum-material boundary for at least the waist section of the taper.

9. The multi-mode optical fiber taper of claim 1, wherein the optical fiber taper is composed of a material selected from one of the group comprising: silicon dioxide, fluorozirconate, fluoroaluminate, chalcogenide, sapphire and silicon

10. The multi-mode optical fiber taper of claim 1, wherein the first radius is equal to the second radius.

11. The multi-mode optical fiber taper of claim 1, wherein a first optical mode and a second optical mode pass through the first tapered transition section, the axially homogeneous waist section, and the second tapered transition section with a greater than 75% transmission for the first optical mode, and a greater than 10% transmission for the second optical mode.

12. A system of generating a Brillouin signal resonance response by forward inter-modal Brillouin scattering with fundamental acoustic modes (FIM-FAM), comprising:
the multi-mode optical fiber taper of claim 1; and
a plurality of polarization controllers optically connected to the first multi-mode fiber section of the taper.

13. The system of claim 12, further comprising: a mode selective coupler optically connected to the first multi-mode fiber section of the taper, wherein said mode selective coupler combines at least a first optical mode to a second optical mode to become combined within the first multi-mode fiber section.

14. The system of claim 13, wherein the mode selective coupler is selected from one of the group comprising: a mode converting device, a spatial light modulator, an on-chip mode splitter or a photonic lantern.

15. A method of generating a Brillouin signal resonance response by forward inter-modal Brillouin scattering with fundamental acoustic modes (FIM-FAM), comprising the steps of:
generating a first optical mode in a first optical fiber, wherein the first optical mode is a fundamental optical mode;
generating a second optical mode in a second optical fiber, wherein the second optical mode is a higher-order optical mode;
coupling through a mode selective coupler the first optical mode to the second optical mode to become coupled optical modes;
controlling through a plurality of polarization controllers polarization of the coupled optical modes;
transmitting the coupled optical modes within an input multi-mode optical fiber, wherein the input multi-mode optical fiber is connected to said plurality of polarization controllers;
driving a fundamental acoustic mode in a multi-mode optical fiber taper of claim 1,
wherein the coupled optical modes enter the multi-mode optical fiber taper from the input multi-mode optical fiber taper; and
wherein at least one Brillouin signal resonance response is generated within the multi-mode optical fiber taper.

16. The method of claim 15, wherein a single Brillouin signal response is generated within the multi-mode optical fiber taper.

17. The method of claim 15, wherein more than one Brillouin signal response is generated within the multi-mode optical fiber taper.

18. The method of claim 15, wherein the fundamental acoustic mode is flexural.

19. The method of claim 15, wherein the fundamental acoustic mode is torsional.

20. The method of claim 15, wherein the fundamental acoustic mode is longitudinal.

21. (canceled)
